(19) United States
(12) Patent Application Publication
(10) Pub. No.: US 2013/0014251 A1
(43) Pub. Date: Jan. 10, 2013

(54) SUBSTRATE PROCESSING APPARATUS

(75) Inventor: Shigeki Nogami, Toyama-shi (JP)

(73) Assignee: HITACHI KOKUSAI ELECTRIC INC., Tokyo (JP)

(21) Appl. No.: 13/583,468

(22) PCT Filed: Mar. 18, 2011
(86) PCT No.: PCT/JP2011/056544

§ 371 Date: Sep. 14, 2012

(30) Foreign Application Priority Data
Mar. 19, 2010 (JP) 2010-065048
Oct. 15, 2010 (JP) 2010-232953

(51) Int. Cl. G06F 21/00

(52) U.S. Cl. 726/19

(57) ABSTRACT

An operating section including an operation screen and amounting section, comprises a data authentication unit configured to collate authentication data when a device is inserted into the mounting section, which is the device into which the authentication data such as at least user ID and user password is integrated, and completes log-in when the authentication data is registered, and a display control unit is configured to perform changeover of a display state of at least a part of the operation screen.

The present application is based on Japanese Patent Applications, No. 2010-065048 and 2010-232953 filed on Mar. 19 and Oct. 15, 2010, the entire contents of which are hereby incorporated by reference.

### TECHNICAL FIELD

The present invention relates to operability in log-in processing and log-out processing in a substrate processing apparatus.

### DESCRIPTION OF RELATED ART

Log-in processing in a conventional substrate processing apparatus is carried out by displaying an authentication screen (log-in screen) provided in an operating section (for example, see patent document 1). In order to carry out log-in processing to a system, the log-in screen is displayed and user ID and password are inputted on the log-in screen from an input device such as a keyboard provided to the substrate processing apparatus.

Further, according to patent document 1, when a prescribed time is elapsed without carrying out operation at all, log-out processing is automatically carried out from an aspect of safety of the substrate processing apparatus.

### PRIOR ART DOCUMENT

### Patent Document

### Patent Document 1;

Japanese Patent Laid Open Publication No. 2008-112968

### SUMMARY OF THE INVENTION

### Problem to be Solved by the Invention

In the above-described conventional substrate processing apparatus, the log-in screen is displayed and the log-in processing needs to be repeatedly carried out, every time the log-out processing is carried out. Therefore, it is troublesome to input the user ID and the password. Further, there is also a risk of forgetting the password because the password is not usually used, and a risk of a shut-down of a screen operation by typing mistakes, etc., of a keyboard. Thus, safety is regarded as important in a semiconductor plant, and there is a tendency of limiting the screen operation itself of the substrate processing apparatus.

An object of the present invention is to provide a substrate processing apparatus capable of improving operability in log-in processing and log-out processing.

### Means for Solving the Problem

According to an aspect of the present invention, there is provided a substrate processing apparatus comprising an operating section including an operation screen for preparing or editing a file for processing a substrate, and a mounting section for installing an external storage unit and an input unit, the operating section further including a data authentication unit in which data for device authentication registered in the operating section and authentication data integrated into the device are collated with each other when a device with authentication data of at least user ID and user password, etc., integrated therein is inserted into the mounting section, and log-in is completed when the authentication data integrated into the device is registered in the data for device authentication; and a display control unit configured to perform changeover of a display state of at least a part of the operation screen, when the log-in is completed.

### Advantage of the Invention

According to the present invention, screen operation in log-in processing and log-out processing can be omitted, and therefore operability is improved. Further, safety of an apparatus can be surely secured by carrying out a specific processing by a specific user. In addition, erroneous operation by other user can be prevented by limiting the screen operation, and the safety of the apparatus can be further secured. Similarly, operation by other user during the specific processing can be limited or inhibited.

### BRIEF DESCRIPTION OF THE DRAWINGS

FIG. 1 is a view showing a menu screen and an authentication screen being an operation screen displayed when a prescribed processing is carried out to a substrate processing apparatus according a first embodiment of the present invention, wherein FIG. 1(a) shows a menu screen, and FIG. 1(b) shows an authentication screen.

FIG. 2 is an explanatory view showing a storage area and a storage content of a USB device of the substrate processing apparatus according to a modified example of the first embodiment of the present invention.

FIG. 3 is a view showing an operation screen of the substrate processing apparatus according to the first embodiment and its modified example of the present invention, wherein (a) shows a data backup screen, (b) shows a maintenance screen, (c) is an explanatory view in a non-active state of a prescribed button in the operation screen, (d) is an explanatory view in an active state of the prescribed button in the operation screen, and (e) is an explanatory view of a warning display example regarding a specific button in the operation screen.

FIG. 4 is a block diagram showing a control system as a center, regarding a schematic structure of the substrate processing apparatus according to the first embodiment of the present invention.

FIG. 5 is a block diagram of a USB device of the substrate processing apparatus according to the first embodiment of the present invention.

FIG. 6 is a transparent perspective view of a process apparatus used for the substrate processing apparatus according to the first embodiment of the present invention.

FIG. 7 is a side perspective view of the process apparatus used for the substrate processing apparatus according to the first embodiment of the present invention.

FIG. 8 is a view showing a function structure of a control program executed by a controller of the substrate processing apparatus according to the first embodiment of the present invention.

FIG. 9 is a flowchart of user log-in of the substrate processing apparatus according to the first embodiment of the present invention.

FIG. 10 is other block diagram of the USB device of the substrate processing apparatus according to a modified example of the first embodiment of the present invention.

FIG. 11 is a flowchart of backup of data performed subsequent to completion of user switching of the substrate processing apparatus according to a modified example of the first embodiment of the present invention.

FIG. 12 is a flowchart of a maintenance performed subsequent to completion of the user switching of the substrate processing apparatus according to a modified example of the first embodiment of the present invention.

FIG. 13 is a flowchart when the USB device is inserted during processing of the substrate by the substrate processing apparatus according to a modified example of the first embodiment of the present invention.

FIG. 14 is a flowchart for displaying an operation screen of the substrate processing apparatus according to a second embodiment of the present invention.

FIG. 15 is a flowchart for performing changeover of a display state of the operation screen of the substrate processing apparatus according to a second embodiment of the present invention.

FIG. 16 is a flowchart of an indicated display in the operation screen performed subsequent to completion of the log-in processing of the substrate processing apparatus according to a modified example of the second embodiment of the present invention.

FIG. 17 is a flowchart of a changeover setting of the display state of the operation screen performed subsequent to completion of the log-in processing of the substrate processing apparatus according to a modified example of the second embodiment of the present invention.

FIG. 18 is a flowchart of automatic execution of a specific operation performed subsequent to completion of the log-in processing of the substrate processing apparatus according to a third embodiment of the present invention.

### DETAILED DESCRIPTION OF THE INVENTION

### First Embodiment

First embodiment of the present invention will be described hereafter.

(1-1) Outline of the First Embodiment

An outline of embodiments of the present invention will be described first. The substrate processing apparatus of this embodiment is a semiconductor manufacturing device for manufacturing a semiconductor device such as IC by a wafer made of silicon (Si). There are a vertical type and a single wafer type in the semiconductor manufacturing device.

According to embodiments of the present invention, when a prescribed device is inserted into a mounting section into which the device can be inserted and extracted, data for device authentication previously registered in an operating section and authentication data integrated into the device are collated, and when the authentication data integrated into the device is registered in the data for device authentication, log-in processing is completed. Thus, the log-in processing can be performed only by inserting a prescribed device into the mounting section. Note that the log-in processing using the prescribed device is sometimes performed after other user's log-in performed before. The log-in processing in this case is sometimes called user switching or user interruption processing. The log-in processing will be mainly described hereafter. However, it is a matter of course that a structure as will be described hereafter can also be applied to the user switching and the user interruption processing.

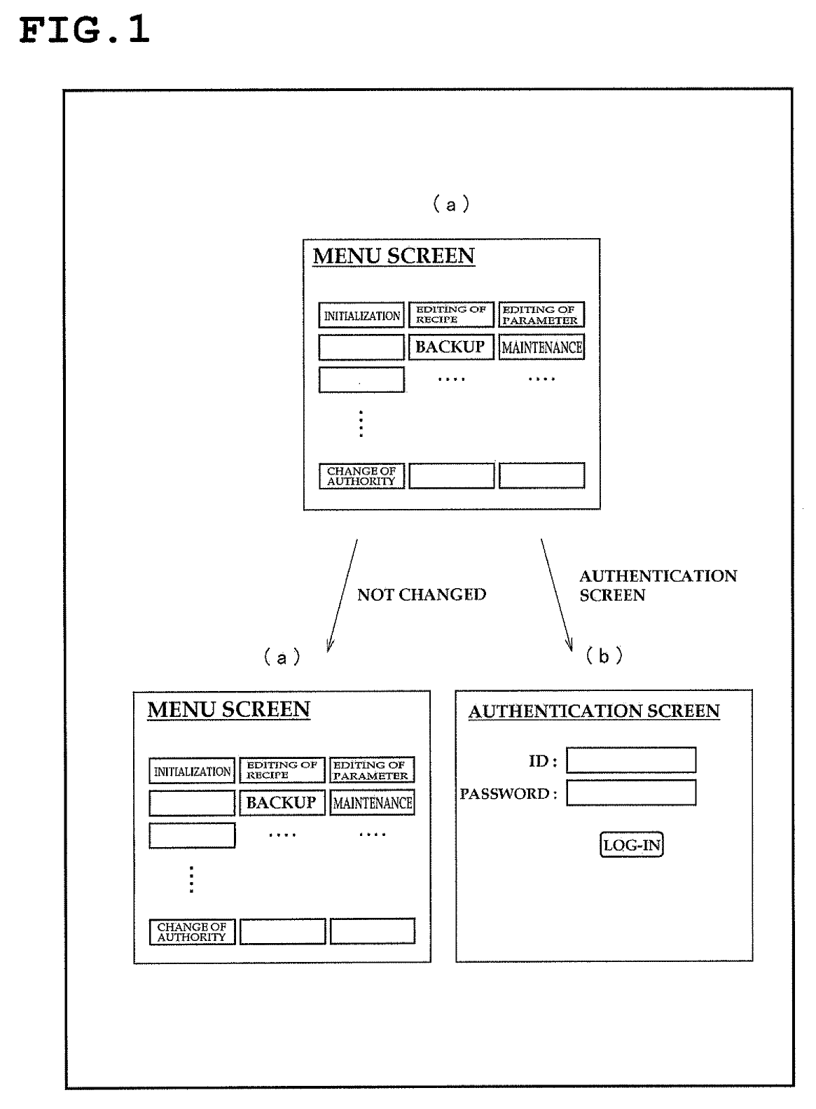

An operation of the log-in processing will be specifically described using FIG. 1.

FIG. 1 shows an operation screen displayed in a displayer of the operating section in the substrate processing apparatus according to the first embodiment of the present invention. FIG. 1(a) shows a menu screen displayed when a prescribed processing is performed to the substrate processing apparatus, and FIG. 1(b) shows an input screen (log-in screen) of the authentication data for user log-in, respectively.

As shown in FIG. 1(a), the menu screen includes a plurality of buttons for indicating, for example, initialization processing, recipe editing processing, parameter editing processing, . . . and processing of authority change, etc. When a driving recipe and an apparatus parameter are edited, a user performs such a processing by pressing a button corresponding to a desired processing in the menu screen.

When the log-in is performed without using the device, an authority change button is pressed as conventional, to thereby perform changeover of the operation screen to an authentication screen (log-in screen) shown in FIG. 1(b) from a menu screen of FIG. 1(a), and input authentication data such as user ID and user password.

In addition, according to this embodiment, log-out processing is automatically completed only by extracting the device from the mounting section of the operating section without opening the authentication screen. The log-out processing without using the device, is performed as conventional by displaying the log-in screen and pressing a log-out button.

Meanwhile, according to this embodiment, the log-in processing can be completed while displaying the menu screen, and there is no necessity for inputting the authentication data. Therefore, the user is free from a trouble of inputting the user ID and the password at the time of log-in processing. Further, there is no necessity for inputting the authentication data, and therefore the operation is not inhibited by typing mistakes, etc. In addition, message showing a processing state may be displayed on the menu screen, whether it is in the middle of the log-in processing or after completion of the log-in processing. Further, the processing state may be switched to a prescribed screen in the middle of the log-in processing or after completion of the log-in processing.

In a case of the first embodiment, when the device inserted into the mounting section and authentication is carried out, operation authority is preferably set to a user level based on the authentication data. The user can subsequently perform specific processing (for example, recipe editing and parameter editing, etc.) which is selected according to the user level. Moreover, in the specific processing, a monitor screen can be displayed for monitoring data detected by each component. Thus, data of a daily inspection parameter (daily inspection data) regarding facility (utility) for example, can be displayed. Thus, information of the facility associated with the substrate processing apparatus can be obtained on the operation screen.

Further, when the operation authority is returned to a previous user by extracting the device, there is no necessity for carrying out log-in again by the previous user, and this is more preferable.

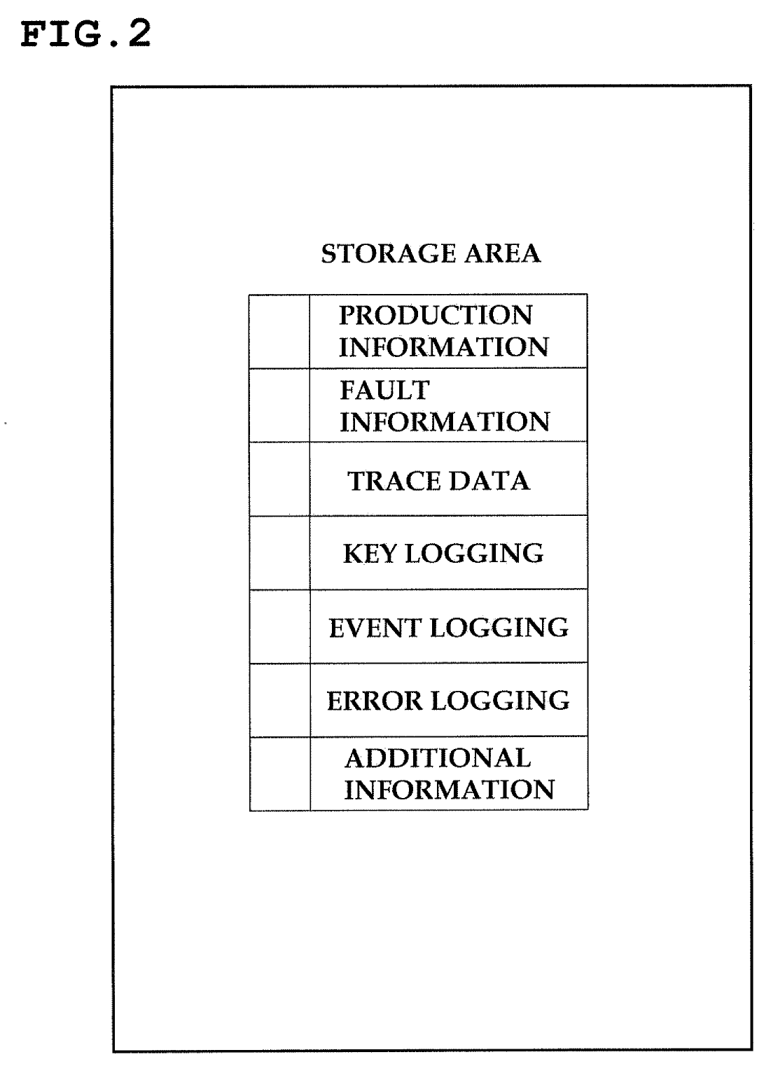

Further, as described above, some of the device has the storage unit for storing prescribed data, other than simply the authentication data. Accordingly, when the device having the storage unit storing the prescribed data as described above, is inserted into the mounting section, the prescribed data of the substrate processing apparatus can also be stored in the storage unit. As shown in FIG. 2 for example, the prescribed data stored in the storage area of the storage unit, is preferably any one or two or more of production information showing at least the past production state of the apparatus (production data), failure information showing an apparatus state when failure occurs, trace data, key logging data, event logging data, and error logging data. Further, data regarding the facility (utility) in association with the substrate processing apparatus may also be included.

With this structure, the log-in processing can be carried out only by inserting the device into the mounting section, and the prescribed data of the substrate processing apparatus can be stored, and the operability in the log-in processing and the operability in user switching can be further improved.

Further, a specific operation can also be executed using the device having the storage unit by further previously storing additional information in the storage area. Wherein the additional information is the information for giving a command to the operating section to cause it to execute a function of operating the operating section (here, the information generally includes data of instruction or command). For example, this is the information to subsequently open an indicated screen. Accordingly, when the operating section performs the specific operation using the device storing such additional information, the operability in user switching can be further improved. The specific operation is given such as opening a data collection screen collecting each kind of data, opening a data backup screen, opening a maintenance screen, opening a recipe editing screen, and opening a parameter editing screen.

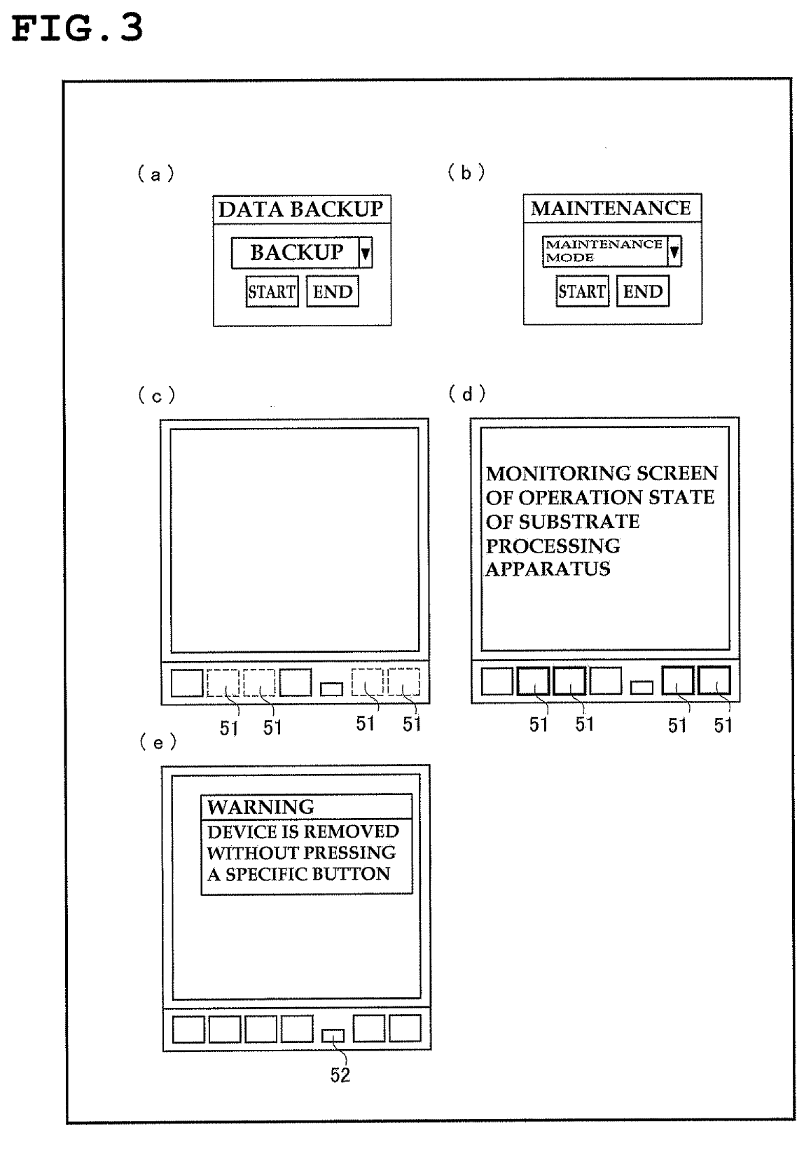

Specifically, for example, the operating section is configured to open the data backup screen after user switching, and with this structure, when the device storing the additional information of opening the data backup screen is inserted into the mounting section, the data backup screen shown in FIG. 3(a) is automatically displayed after user switching. Further, when start of data backup is inputted to the data backup screen, the operating section can start backup of the data. When the device is selected to be a backup destination, the prescribed data can be stored in the device as backup data.

Thus, when the device, to which a data backup function is assigned, is inserted into the mounting section, the operation screen is automatically switched to the data backup screen after user switching. Therefore, data backup operation can be simplified, and the data can be easily backed-up in the device. Thus, the operability in user switching can be further improved. In this case, for example, only a specific data such as failure information and error logging data can be collected when a trouble of the substrate processing apparatus occurs for example. Then, the risk of data leak can be prevented, and the safety can be further secured.

Further, when the device storing the additional information (maintenance screen shifting instruction) to open the maintenance screen, is inserted into the mounting section, the maintenance screen shown in FIG. 3(b) is automatically opened after user switching. Further, when the start of the maintenance is inputted to the maintenance screen, the operating section can start the maintenance. In this case, for example, the device may be prepared for each component being a maintenance object for example, or the component may be selected in the maintenance screen.

Thus, when the device to which the maintenance function is assigned, is inserted into the mounting section, the operation screen can be switched to the maintenance screen for performing a specific operation. Therefore, the maintenance operation can be simplified, and the maintenance can be further easily started. Thus, the operability in user switching can be further improved.

Further, the operating section is configured to stop execution of a file for processing the substrate, when the device is inserted into the mounting section during processing the substrate. In addition, the operating section is also configured to execute the file for performing changeover of the apparatus state to a safety state after execution of the file for processing the substrate is stopped. In this case, for example the following commands are indicated as the additional information: a command of forcibly shifting the apparatus state to an end step, and a command of temporarily waiting in a step of error occurrence.

Thus, the execution of the file for processing the substrate is stopped after user switching, when the device is inserted for performing the specific operation during processing the substrate. Therefore, it can be prevented to erroneously continue this file by other user. Further, when the additional information includes an alarm recipe and an abort recipe as additional information, to execute the file for shifting the apparatus state to the safe state, the apparatus state can be shifted to the safe state only by inserting the device. However, generally it is preferable to manage the device so that only a specific user can execute the recipe for shifting the apparatus state to the safe state. In addition, the operation screen for executing the alarm recipe and the abort recipe may be displayed only by inserting the device, when the error occurs in the substrate processing apparatus. Thus, these recipes can be executed, and therefore the apparatus can be speedily returned to the safe state.

Note that when re-execution of the file is possible by extracting the device, etc., preferably the apparatus state is returned to an original state from the safe state, so that the file for processing the substrate can be continued.

Further, when the device is not inserted into the mounting section, a prescribed button on the operation screen is displayed as non-active, thereby not permitting press of the button. As such a non-active display example, color of the prescribed button is preferably selected to be a similar color as the color of a background of the screen. Wherein, as the prescribed button, either a button for recipe editing or parameter editing, etc., (FIG. 1(a)), or a button 51 displayed in a prescribed area of the operation screen, can be used (FIG. 3(c)).

Thus, when the button is not permitted to be pressed according to the user level, the authority of the user can be clarified, and processing without authority is prevented from being executed by the user, etc., before the device is inserted.

Note that when the device is mounted on the mounting section, preferably the prescribed button 51 on the operation screen is displayed as active, which can be selected by the user level based on the authentication data of the device, so that the button 51 can be pressed. Further, as shown in FIG. 3(d), preferably the prescribed button 51 is displayed as active in an area which is not shifted (fixed display area) even by a previously determined operation on the operation screen, or even by a display operation of changeover of the operation screen for monitoring an operation state of the substrate processing apparatus.

Thus, when the prescribed button 51 that can be selected by the inserted device, is displayed as active in the fixed display area so that the button 51 can be pressed, the authority of the user is clarified, and even when the operation screen is switched, the processing with authority can be easily executed by the user who inserts the device. Thus, the operability in user switching can be further improved.

Further, as shown in FIG. 3(e), when the device having the storage unit is extracted from the mounting section without pressing the specific button 52 for displaying right or wrong of unmounts operation of the device, preferably warning is issued on the operation screen for notifying the user of the extraction of the device without pressing the specific button 52. The warning is preferably displayed on the operation screen for example.

Thus, when the warning is issued for notifying the user of a fact that the device is extracted without pressing the specific button 52 in a case that the device is extracted without pressing the specific button 52, prescribed data, etc., stored in the storage unit of the device can be effectively protected. Preferably, when the device is extracted without pressing the specific button 52, the log-out processing is preferably in a state of not being completed. Then, the user surely extracts the device after pressing the specific button 52. Further, in a non-completion state of the log-out processing, the operation is preferably not permitted (operation failure). Then, further more safety of the apparatus can be maintained. For example, in order to release the operation failure, it can be released by inserting a prescribed releasing device. Then, the log-out processing is completed by extracting the releasing device. Thus, only by providing the step of checking the button 52, in the step of completing the log-out processing by extracting the device, the data can be further effectively protected. In this way, the operability and the safety in user switching can be further improved. Wherein, the operation failure means a state that input on the operation screen can't be completely received.

(1-2) Outline Structure of the Substrate Processing Apparatus

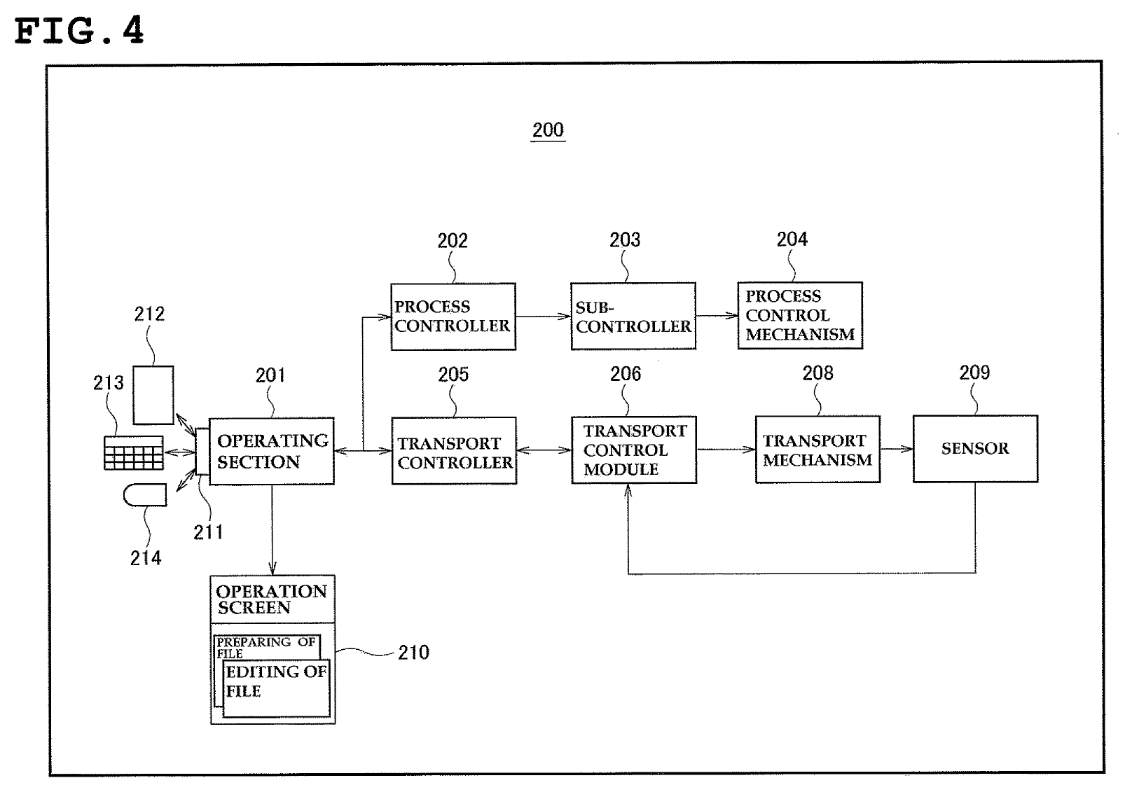

A structure of the substrate processing apparatus according to this embodiment will be schematically described, with reference to mainly FIG. 4. Details of FIG. 4 will be described later.

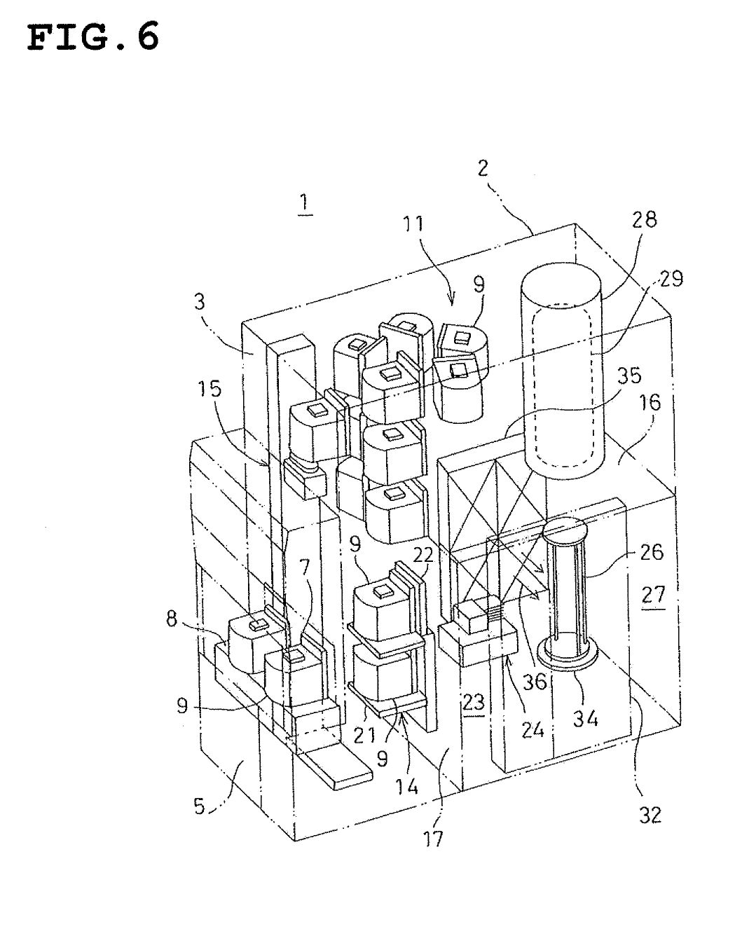

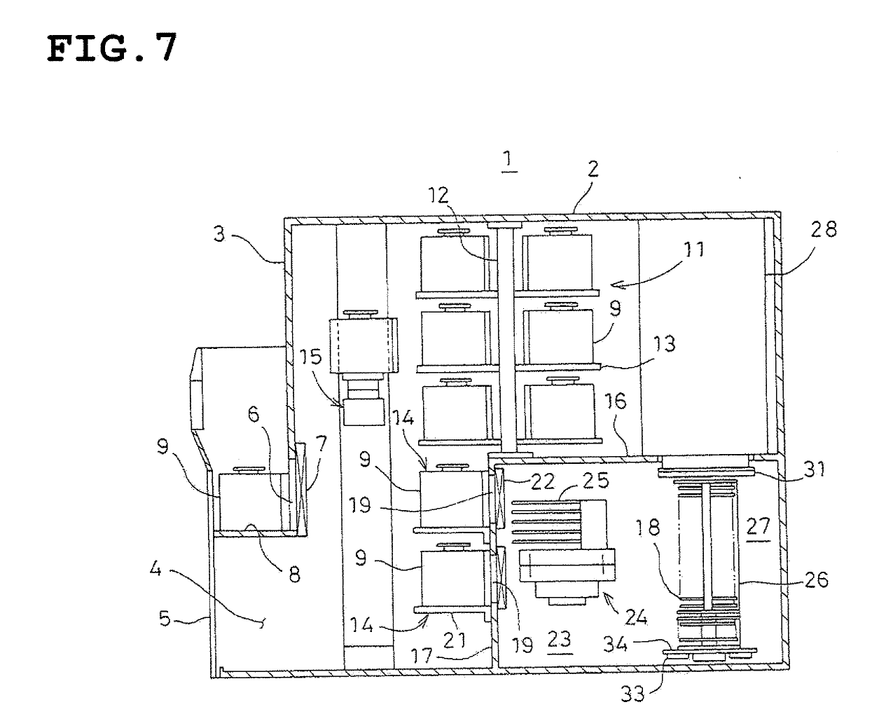

The substrate processing apparatus includes a process apparatus 1 that performs processing of the substrate in accordance with a file for processing the substrate (see FIG. 6 and FIG. 7), and a controller 200 that controls the process apparatus 1 (see FIG. 4). The process apparatus 1 and the controller 200 are electrically connected to each other. As shown in FIG. 4, the controller 200 includes a mounting section 211 for mounting an external storage unit 212 and an input unit 213, etc. Further, the mounting section 211 is formed so that a device 214 having authentication data integrated therein, can be inserted and extracted. Note that the controller 200 may be incorporated into the process apparatus 1, and in this case, the process apparatus 1 with the controller 200 incorporated therein is called the substrate processing apparatus.

(1-3) Structure of the Process Apparatus

The process apparatus included in the substrate processing apparatus according to this embodiment will be described based on FIG. 6 and FIG. 7.

FIG. 6 and FIG. 7 show a vertical-type process apparatus 1 that performs film formation processing by a thermal CVD (Chemical Vapor Deposition) method, etc., for example. Note that a wafer 18 made of silicon, etc., is shown for example, as the substrate processed by the process apparatus 1.

The process apparatus 1 includes a casing 2 wherein a front maintenance port 4 is opened in a lower part of a front wall 3 of the casing 2, as an opening part so that the maintenance can be performed, and the front maintenance port 4 is opened/closed by a front maintenance door 5.

A pod loading/unloading port 6 is opened on the front wall 3 of the casing 2 so as to communicate with inside/outside of the casing 2, and the pod loading/unloading port 6 is opened and closed by a front shutter (loading/unloading port open/close mechanism) 7. A load port (substrate carrier vessel transfer table) 8 is installed in front of the pod loading/unloading port 6, so that mounted pods 9 are positioned on the load port 8.

Each pod 9 is an air-tightly sealed substrate carrying vessel, and is loaded on the load port 8, and is unloaded from the load port 8, by an in-step carrier not shown.

A rotary pod shelf (substrate carrier vessel storage shelf) 11 is installed in an upper part in a laterally substantial center of the casing 2, so that a plurality of pods 9 are stored in the rotary pod shelf 11.

The rotary pod shelf 11 has a support 12 which is vertically erected and intermittently rotated, and multiple stages of shelf plates (substrate carrier vessel mounting shelves) 13 which are radially supported by the support 12 at each position in upper, middle, and lower stages, wherein the shelves 13 are stored in a state that a plurality of pods 9 are mounted thereon.

A pod opener (substrate carrier vessel lid member open/close mechanism) is provided in a lower part of the rotary pod shelf 11, wherein the pod 9 is mounted on the pod opener 14 so that a lid of the pod 9 can be opened and closed.

A pod carrier (vessel carrier) 15 is installed between the load port 8, the rotary pod shelf 11, and the pod opener 14, so that the pod carrier 15 can be elevated in CZ axis direction, with pod 9 held therein, and can be retreated and advanced in CX axis direction, to thereby carry the pod 9 among the load port 8, the rotary pod shelf 11, and the pod opener 14.

A sub-casing 16 is provided so as to extend to a rear end, in a lower part in a laterally substantial center of the casing 2. A pair of wafer loading/unloading ports (substrate loading/unloading ports) 19 are opened on a front wall 17 of the sub-casing 16, arranged side by side vertically in upper and lower two stages, for loading/unloading the wafer (substrate) 18 into the sub-casing 16, and pod openers 14 are provided to the wafer loading/unloading ports 19, 19 in upper and lower stages respectively.

Each pod opener 14 includes a mounting table 21 for mounting the pod 9 thereon, and an open/close mechanism 22 for opening and closing the lid of the pod 9. The pod opener 14 is configured to open and close a wafer charging/discharging port of the pod 9 by opening and closing the lid of the pod 9 mounted on the mounting table 21, by the open/close mechanism 22.

The sub-casing 16 partitions a transfer chamber 23 which is air-tightly formed by a space (pod transferring space) in which the pod carrier 15 and the rotary pod shelf 11 are arranged. A wafer transfer mechanism (substrate transfer mechanism) 24 is installed in a front side area of the transfer chamber 23, wherein the wafer transfer mechanism 24 includes prescribed number of (five in the figure) wafer mounting plates 25 for mounting the wafer 18 thereon, and the wafer mounting plates 25 can be linearly moved and rotated in a horizontal direction or elevated. A notch aligner (not shown) being a substrate aligner for aligning a position of the wafer 18 in a circumferential direction, is installed in the vicinity of the wafer transfer mechanism 24, namely between the wafer transfer mechanism 24 and a clean unit 35 as will be described later. The wafer transfer mechanism 24 is configured to charge and discharge the wafer 18 into/from a boat (substrate holding tool) 26 as will be described later.

In addition, in the wafer transfer mechanism 24, four parameters of X-axis, Y-axis, Z-axis, and V-axis, are set when the wafer 18 is taken from a prescribed place and is placed in a prescribed place by the wafer mounting plates 25 in which the wafer 18 is held, wherein the X-axis is the axis of adjusting an operation of the wafer mounting plates 25, the Y-axis is the axis of adjusting an advancing angle of the wafer 18 when the wafer 18 is transferred to the boat 26 by the wafer mounting plates 25, and the Z-axis is the axis of adjusting an advancing height of the wafer 18 when the wafer 18 is transferred to the boat 26 by the wafer mounting plate 25, and the V-axis is the axis of adjusting an insertion distance to the boat 26 of the wafer 18 by performing fine adjustment of the Z-axis.

A waiting section 27 in which the boat 26 is housed and waited, is formed in a rear side area of the transfer chamber 23, and a vertical type processing furnace 28 is provided in an upper part of the waiting section 27. A processing chamber 29 is formed inside of the processing furnace 28, and a furnace throat part is formed in a lower end part of the processing chamber 29 so that the furnace throat part is opened/closed by a furnace throat shutter (furnace throat open/close mechanism) 31.

A boat elevator (substrate holding tool elevation apparatus) 32 for elevating/lowering the boat 26 is installed between a right side end part of the casing 2, and a right side rear part of the waiting section 27 of the sub-casing 16. A seal cap 34 is horizontally attached to an arm 33 being a lid member connected to an elevation table of the boat elevator 32. The boat 26 is vertically supported by the seal cap 34, and the furnace throat part is air-tightly closed in a state that the boat 26 is charged into the processing chamber 29.

The boat 26 is configured to hold a plurality of (for example about 50 to 125) wafers 18 in multiple stages in a horizontal posture with centers thereof aligned.

A clean unit 35 is disposed at a position opposed to the side of the boat elevator 32. The clean unit 35 is composed of a supply fan for supplying clean air 36 such as cleaned atmosphere or inert gas, and a dust-free filter. The clean air 36 blown-out from the clean unit 35 is circulated through the notch aligner (not shown) and the wafer transfer mechanism 24, and the boat 26, and thereafter is sucked by a duct not shown, and is exhausted to outside of the casing 2 or is blown-out into the transfer chamber 23 by the clean unit 35.

(1-4) Operation of the Process Apparatus

An operation of the process apparatus 1 controlled based on the driving recipe and the apparatus parameter, will be described next in detail, with reference to FIG. 6 and FIG. 7. Note that such an operation is controlled by an apparatus controller 412 of a control program as will be described later.

When the pod 9 is supplied to the load port 8 shown in FIG. 6 and FIG. 7, the pod loading/unloading port 6 is opened by the front shutter 7. The pod 9 on the load port 8 is loaded into the casing 2 through the pod loading/unloading port 6 by the pod carrier 15, and is mounted on a specified shelf plate 13 of the rotary pod shelf 11. The pod 9 is temporarily stored on the rotary pod shelf 11, and thereafter is carried to either one of the pod openers 14 from the shelf plate 13 by the pod carrier 15, and is transferred to the mounting table 21, or is directly transferred to the mounting table 21 from the load port 8.

At this time, the wafer charging/discharging port 19 is closed by the open/close mechanism 22, and the clean air 36 is circulated through the transfer chamber 23 which is filled with this clean air. For example, by filling the transfer chamber 23 with nitrogen (N₂) gas for example as the clean air 36, oxygen (O₂) concentration in the transfer chamber 23 is set to 20 ppm or less, which is significantly lower than the oxygen concentration in the casing 2 (atmosphere).

An opening side end face of the pod 9 mounted on the mounting table 21 is pressed against an opening edge part of the wafer charging/discharging port 19 on the front wall 17 of the sub-casing 16, and the lid of the pod 9 is released by the open/close mechanism 22 to open the wafer charging/discharging port.

When the pod 9 is opened by the pod opener 14, the wafer 18 is taken out from the pod 9 by the wafer transfer mechanism 24, and is transferred to the notch aligner (not shown). Then, the wafer 18 is aligned by the notch aligner, and thereafter the wafer 18 is loaded into the waiting section 27 in the rear side of the transfer chamber 23 by the wafer transfer mechanism 24, and is charged into the boat 26 (charging).

The wafer transfer mechanism 24 that transfers the wafer 18 to the boat 26, is returned to the pod 9, so that the next wafer 18 is charged into the boat 26.

Meanwhile, during work of charging the wafer 18 into the boat 26 by the wafer transfer mechanism 24 in one of the pod openers 14 (upper stage or lower stage), another pod 9 is carried by the pod carrier 15 from the rotary pod shelf 11 and is transferred to the other pod opener 14 (lower stage or upper stage), and an opening work of the pod 9 by the other pod opener 14 is simultaneously performed.

When previously specified numbers of wafers 18 are charged into the boat 26, the furnace throat part of the processing furnace 28 closed by the furnace throat shutter 31 is opened. Subsequently, the boat 26 is elevated by the boat elevator 32, and is loaded into the processing chamber 29 (loading).

After loading, the furnace throat part is air-tightly closed by the seal cap 34.

Subsequently, inside of the processing chamber 29 is vacuum-exhausted by a gas exhaust mechanism (not shown) so as to be a desired pressure (degree of vacuum). Further, the inside of the processing chamber 29 is heated to a prescribed temperature by a heater driving section (not shown) so as to be a desired temperature distribution.

Further, processing gas controlled to a prescribed flow rate is supplied by a gas supply mechanism (not shown), and is brought into contact with the surface of the wafer 18 in a process of circulating through the processing chamber 29, and at this time, a thin film is formed on the surface of the wafer 18 by a thermal CVD reaction. Further, the processing gas after reaction is exhausted from the processing chamber 29 by a gas exhaust mechanism.

After elapse of a previously set processing time, the inert gas is supplied from an inert gas supply source (not shown) by the gas supply mechanism, so that inside of the processing chamber 29 is replaced with the inert gas, and the pressure in the processing chamber 29 is returned to a normal pressure.

The boat 26 is lowered by the boat elevator 32 through the seal cap 34.

Regarding the discharge of the wafer 18 after processing, the wafer 18 and the pod 9 are discharged to the outside of the casing 2 in a reversed procedure to the above-described procedure. Unprocessed wafer 18 is further charged into the boat 26, and batch processing of the wafer 18 is repeated.

(1-5) Detailed Structure of the Substrate Processing Apparatus

A block diagram of the substrate processing apparatus according to a first embodiment of the present invention will be further described in detail, using FIG. 4 with a control system as a center.

As shown in FIG. 4, the controller 200 included in the substrate processing apparatus, is provided with an operating section 201 including a displayer 210 for displaying an operation screen for preparing or editing at least the file for processing the substrate. The operating section 201 includes an external storage unit 212, and a mounting section 211 for mounting the input unit 213. The external storage unit 212 is FD, MO, or HD, etc., for example. The input unit 213 is a mouse or a keyboard, etc., for inputting characters on the operation screen of the displayer 210. One or two or more mounting sections 211 are provided. The mounting section 211 is configured to have the device 214 inserted and extracted thereinto, the device 214 having the authentication data integrated therein. Wherein, the authentication data is the data including user ID and user password. The device 214 is a USB device for example, and at this time, the mounting section 211 is a USE port.

Further, the controller 200 has a process controller (PMC) 202, and under a control of this controller, based on the instruction from the operating section 201, instruction is given to the sub-controller 203 that controls each kind of process control mechanism 204, so that the substrate is processed by executing the file prepared or edited by the operating section 201. Further, the controller 200 has a transport controller 205, and under a control of this controller, based on the instruction from the operating section 201, instruction is given to a transport control module 206 that controls each kind of transport mechanism 208, and the substrate is processed by executing the file prepared or edited by the operating section 201. Further, each kind of transport mechanism 208 includes each kind of sensor 209.

The file including an operation recipe and apparatus parameters is prepared or edited using the operation screen of the displayer 210, and this file is downloaded to the process controller from the operating section 201. Then, based on a content of the operational recipe, etc., in the file downloaded from the operating section 201, the process controller 202 gives a prescribed instruction to the sub-controller 203, and controls each kind of process control mechanism 204. Further, the file is downloaded to the transport controller 205 from the operating section 201. Then, based on the content of the operational recipe in the file downloaded from the operating section 201, the transport controller 205 gives prescribed instruction to the transport control module 206, and controls each kind of transport mechanism, 208. During such a control, detection data of each kind of sensor 209 provided in each kind of transport mechanism 208 being a control target, is fed-back to the transport control module 206.

The controller 200 is composed of the operating section 201 including the displayer 210, the process controller 202, the sub-controller 203, the transport controller 205, and the transport control module 206, to issue prescribed instruction to the substrate based on the operational recipe and the control parameters, etc.

(1-6) Device

The device 214 according to the first embodiment recognizes unique information of itself, and is capable of controlling a system at a user level in association with this information. The device 214 is used as the user ID and an alternate key.

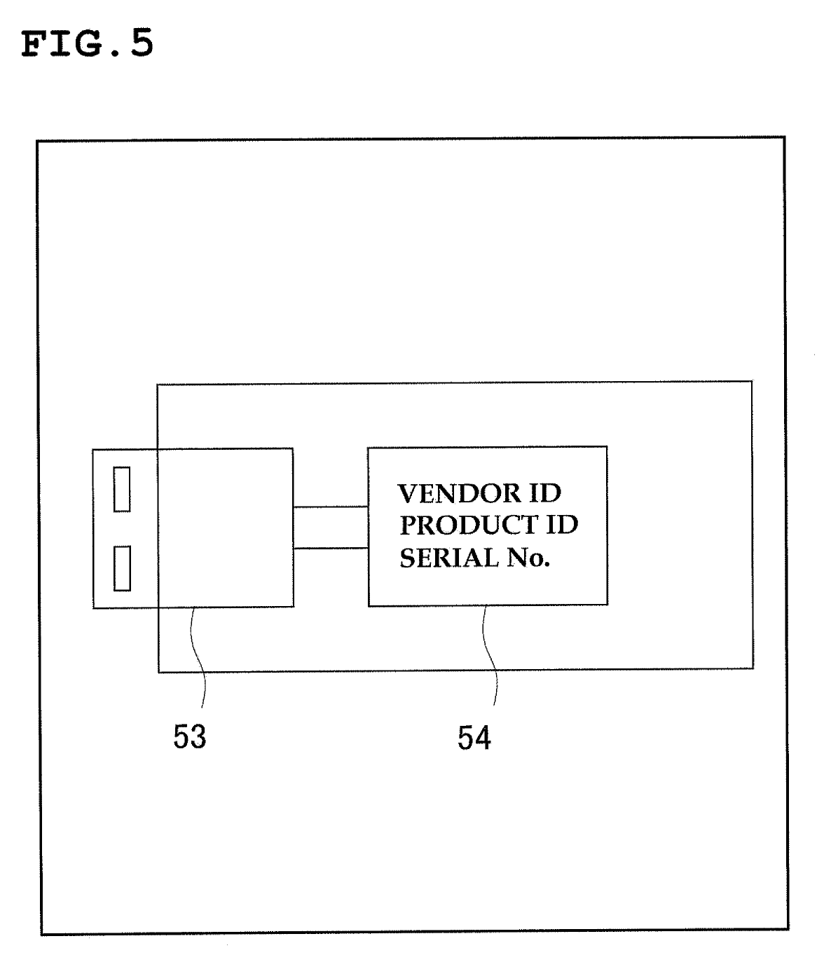

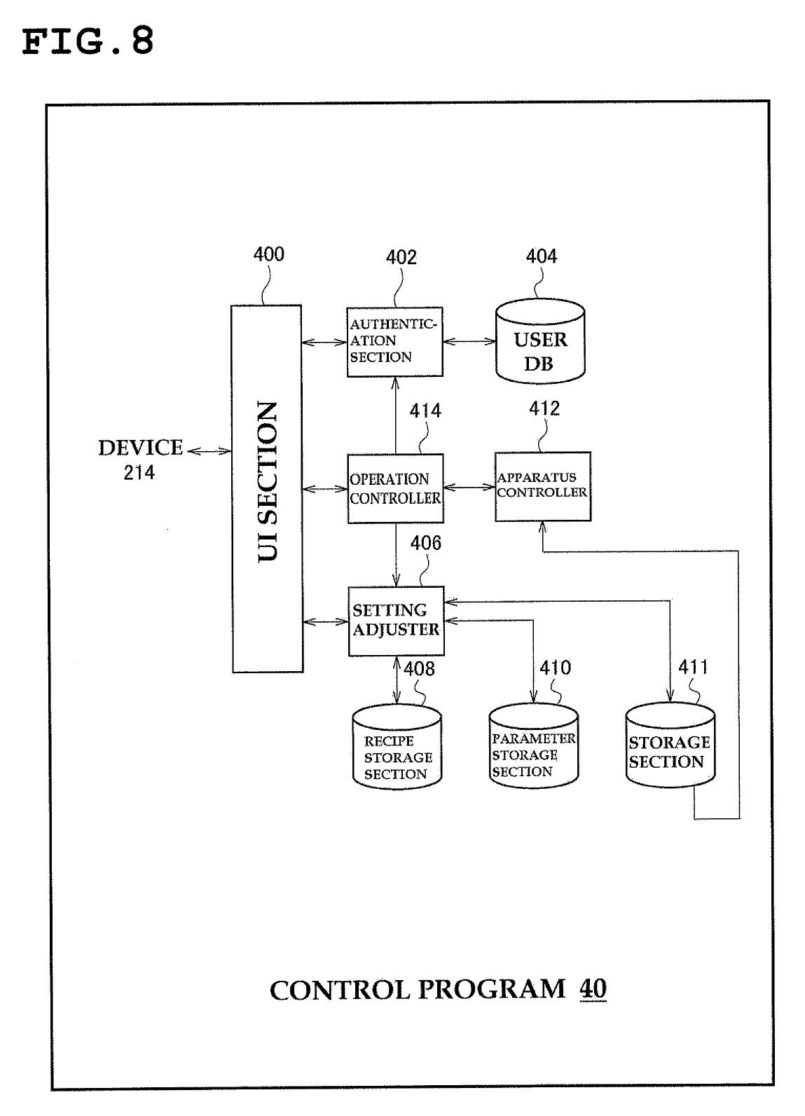

FIG. 5 shows an example of a case that the aforementioned device 214 is the USB device. The USB device includes a connector 53 and a recognition section connected to the connector 53. The recognition section 54 has at least vendor ID, product ID, and serial No. The vendor ID, the product ID, and the serial No. are respectively assigned to the user ID and the user password. Although there is also the USB device not having the serial No., in this case, security is lower than the USB device having the serial No. Accordingly, when high security is required like the substrate processing apparatus, the USB device having the serial No. is preferable. When such a USB device is inserted into the mounting section 211, the operating section 201 acquires the ID and the serial No. of the USB device, and executes a control program 40 (FIG. 8), and recognizes the USE device as a specific key. Although not shown, a storage unit for storing prescribed data may also be formed, in addition to the recognition section 54 being the authentication data. The USB device having the storage unit will be described later.

(1-7) Control Program

FIG. 8 is a view showing a functional structure of the control program executed by the operating section 201 of the substrate processing apparatus according to the first embodiment of the present invention.

As shown in FIG. 8, the control program 40 includes a user interface (UI) section 400, an authentication section 402, a user DB 404, a setting adjuster 406, a recipe storage section 408, a parameter storage section 410, an apparatus controller 412, an operation controller 414, and further a storage section 411 as needed. The control program 40 is supplied to the substrate processing apparatus, and is loaded in a memory (not shown) in the operating section 201, so as to be executed by specifically utilizing the hardware on the OS not shown operated on the operating section 201.

The user interface (UI) section 400, the authentication section 402, the setting adjuster 406, and the operation controller 414 can be realized by the operating section 201 shown in FIG. 4. Further, the user DB 404, the recipe storage section 408, the parameter storage section 410, and the storage section 411 can be realized by the memory or the external storage unit 212 in the operating section 201. Further, the apparatus controller 412 can be realized by the process controller 202, the sub-controller 203, the transport controller 205, and the transport control module 206.

In the control program 40, the UI section 400 is configured to receive an operation of a user performed to the aforementioned external storage unit 212, the input unit 213, and the device 214, and output it to each constitutional portion of the control program 40. Further, the UI section 400 is configured to display information/data prepared by each constitutional portion of the control program 40 and processing content of each constitutional portion, on the displayer 210 of the operating section 201 shown in FIG. 4.

The user DB404 is configured to store the data for authentication such as identifier (ID) of a plurality of users and the password of each user, etc., and the authority of the users (user level) based on the data for authentication for each processing of recipe editing processing and parameter editing processing, etc. Thus, the device 214 having the authentication data, etc., previously stored in the user DB404 is called a registered device 214. The user ID is the identifier for uniquely identifying the user. The password is a prescribed length of character string composed of alphanumeric characters for example, for authenticating the user. The user authentication (user level) will be described as follows, with recipe editing given as an example. The user authority (user level) is any one of “editing” authority for referencing and editing the operation recipe, “reference” authority for referencing the operation authority, and “prohibition authority” for prohibiting either one of the referencing/editing. Any one of the aforementioned authorities is set for each processing by the user.

When the device 214 is inserted into the mounting section 211, the authentication section 402 is configured to receive the user ID and the user password included in the device 214, and reference the user DB404, to thereby authenticate the user. More specifically, when the authentication data such as the user ID and the user password, etc., is received, the authentication section 402 is configured to judge whether or not the password is correct in association with the ID. When it is so judged that the password is correct in association with the ID, the authentication section 402 is configured to permit execution of the processing at the user level based on the authentication data.

Further, when the device 214 is extracted from the mounting section 211, the authentication section 402 is configured to return the authority of the user to the former user. More specifically, when extraction of the device 214 is confirmed, the authentication section 402 is configured to read the user ID and the user password before the device 214 is inserted into the mounting section 211, and set the user authority to the former user.

The recipe storage section 408 is configured to store therein the operation recipe describing the processing content of a plurality of processes. The parameter storage section 410 is configured to store parameters for executing the operation recipe. More specifically, the parameter storage section 410 is configured to store apparatus parameters for changing a state of the substrate processing apparatus and a usable function, etc. Thus, the recipe storage section 408 and the parameter storage section 410 constitute a data storage unit for storing data regarding the function of the substrate processing apparatus. The storage section 411 is configured to temporarily store the data, etc., collected in the substrate processing apparatus.

The setting adjuster 406 constitutes a receiving unit for receiving the operation for editing the data stored in the recipe storage section 408 or the parameter storage section 410. More specifically, the setting adjuster 406 is configured to receive the operation inputted through a recipe editing screen (not shown) or a parameter editing screen (not shown) by the user, and register, delete, and update the apparatus parameter stored in the parameter storage section 410.

The operation controller 414 controls the authentication section 402, and displays an initial screen such as a menu screen or an authentication screen on the displayer 210 of the operating section 201. Further, for example, when insertion (log-in operation) of the device 214 is carried out, the operation controller 414 is configured to control the authentication section 402, and receive the user ID and the user password without displaying the authentication screen. Further, for example, when the user log-in operation is carried out without inserting the device 214, the operation controller 414 is configured to control the authentication section 402 and display the authentication screen, so that the user ID and the user password can be inputted.

Meanwhile, an instruction for processing the substrate is outputted to the apparatus controller 412.

(1-8) Control Processing of the Substrate Processing Apparatus

Control processing of the substrate processing apparatus according to a first embodiment of the present invention will be described next. The following explanation is given on the assumption that the device 214 is the USB device, and the mounting section 211 is the USB port.

(User Log-In)

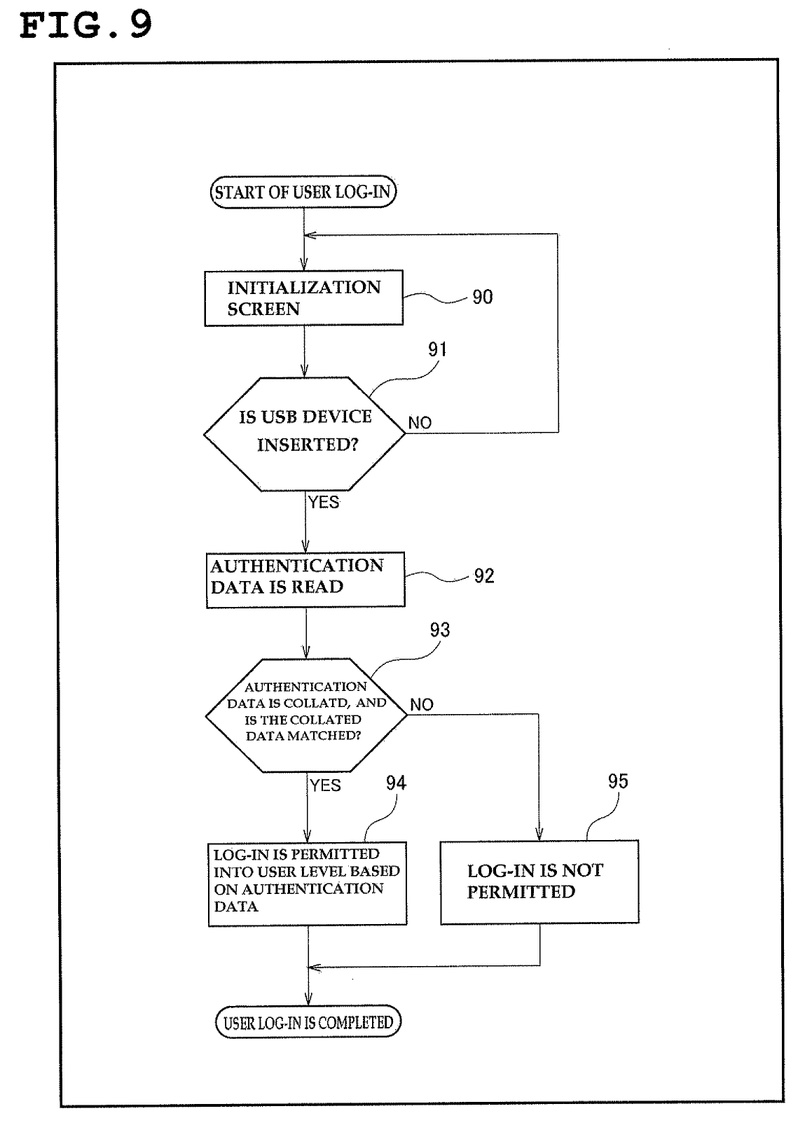

FIG. 9 is a flowchart showing the control processing of the log-in processing based on the control program executed by the substrate processing apparatus according to this embodiment. Here, explanation will be mainly given for the log-in processing (changeover processing) by the user (not a manager), namely, for a user log-in (user switching).

In step 90 shown in FIG. 9, the operation controller 414 of the control program 40 displays the initial screen such as a menu screen on the displayer 210 of the operating section 201 (FIG. 1(a)). In this state, the operation controller 414 judges whether or not the USB device is inserted into the USB port (step 91), and when the USB device is inserted, the processing is advanced to step 92, and otherwise, the processing is returned to step 90.

In step 92, the authentication section 402 controls the operation controller 414, to thereby maintain a state that the initial screen (FIG. 1a (a)) is displayed on the displayer 210 of the operating section 201. The authentication section 402 receives the user ID and the user password read from the USB device, and performs authentication processing. More specifically, the authentication section 402 references the user DB 404, and judges whether or not the user password is correct in association with the user ID (step 93). When the user password is judged to be correct, log-in to the user level based on the authentication level of the user is permitted (step 94) and the user log-in is completed. Thus, in a case of the log-in by other user, the user is switched to a user identified by the user ID integrated into the USE device. When the password is judged to be not correct, the log-in is not permitted (step 95), and the user log-in is completed. When the log-in is not permitted, the user ID and the user password are newly inputted again, or another USE device is inserted into the mounting section 211, so that the user log-in processing can be performed. At this time, when the USE device is used, the USE device not permitted to be logged-in, is preferably removed.

In the control processing after user switching, when a function button that can be used on the menu screen is selected by the user permitted to log-in, the setting adjuster 406 is controlled by the operation controller 414, to display the operation screen on the displayer 210. When the user opens the editing screen as the operation screen, prescribed processing is performed, for example setting of a desired control parameter and setting of a desired apparatus parameter is performed through the editing screen. The setting adjuster 406 judges whether or not the operation by the user is received, and when the operation is received, the control program 40 references and updates the data stored in the recipe storage section 408 and the parameter storage section 410, etc., based on the received operation.

Thus, the user switching can be easily executed only by inserting the USB device into the USB port, wherein display of the authentication screen (log-in screen) and input of the authentication data are entirely omitted. Accordingly, labor of inputting the authentication data such as input of the user ID and input of the password can be effectively prevented, and a prohibition state of a screen operation due to input of an incorrect password can be effectively prevented.

(Log-Out Processing)

The operation controller 414 of the control program 40 judges whether or not the registered USB device is extracted from the USB port in a state of displaying the menu screen on the displayer 210 for example (FIG. 1(a)). When the registered USB device is extracted, the user authority is returned to the user before insertions, to thereby complete the log-out processing. Note that the step of checking the aforementioned specific button 52 can also be added.

Thus, the log-out processing can be easily executed only by extracting the USB device, without displaying the authentication screen (log-in screen) on the displayer 210. Further, the user authority can be automatically returned to the former user when the USB device is extracted, and therefore forgetting of return to the user does not occur. Accordingly, when the user level of the user using the apparatus before is lower than the user level of the user extracting this USE device, erroneous execution of the processing by the former user not having authority, does not occur. Therefore, operability is considerably improved while securing the safety of the apparatus.

As described above, according to this embodiment, an input method by the log-in (changeover processing) without using the USB device, has been explained.

Such a conventional input method of the user ID and the password is left for a case that the apparatus can be operated even when the USE device is lost or the log-in of the USE device is not permitted.

(1-9) Effect of this Embodiment

As described above, according to this embodiment, user log-in and user log-out can be executed only by inserting and extracting the USE device into which at least the authentication data is integrated. Therefore, labor of inputting the authentication data such as input of the user ID and input of the password can be prevented, and a prohibition state of a screen operation due to input of an incorrect password can be prevented. Accordingly, the operability in the log-in processing, for example the operability in the user switching can be improved.

Particularly, when the USE device is inserted, forgetting of the return of the user level for returning the authentication data to the former (original) user does not occur, when the user level is changed to the user level based on the authentication data of this USB device and the USE device is extracted. Particularly, when the apparatus is the substrate processing apparatus, usually the apparatus is operated by the user with a low authority level, and therefore when a specific work such as recipe editing and change of the parameter setting are performed, the user with a high authority level performs the specific work after the log-in processing. When such a specific work is ended, the user with a high authority level executes the log-out processing thereafter, and the user with a low authority level executes the log-in processing again, to operate the apparatus. In this point, when the USB device is extracted as shown in this embodiment, a great merit can be obtained by returning the user authority to the user using before, and the operability in user switching can be further improved.

(1-10) Modified Example of this Embodiment

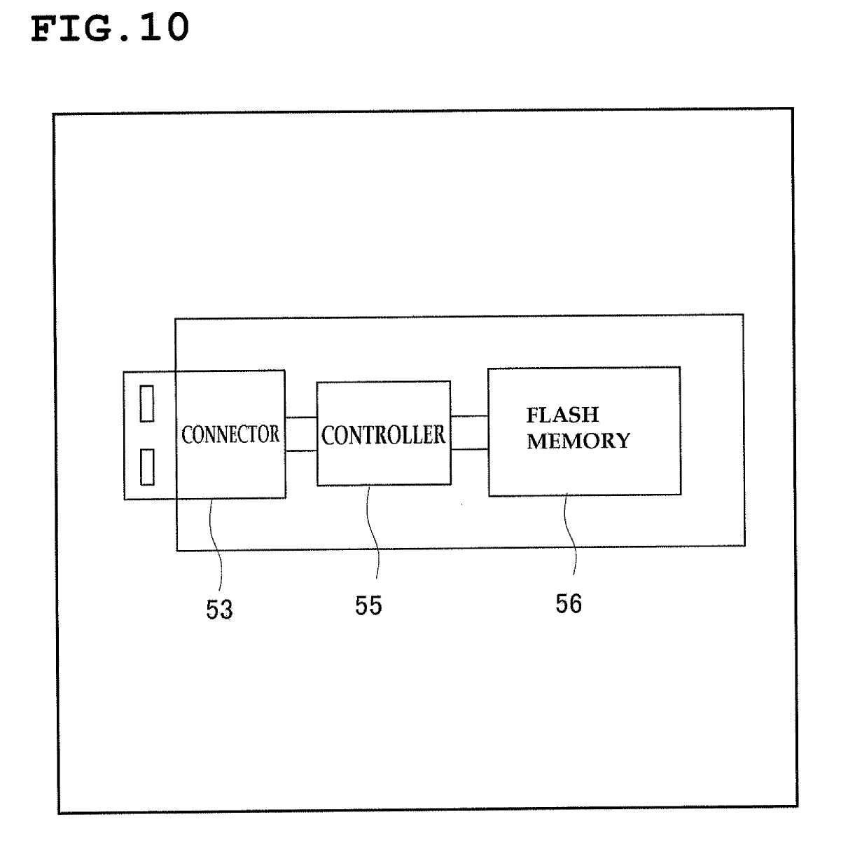

Details of the storage unit of the device 214 are not particularly described in the aforementioned first embodiment. Here, when an additional function is given to the device having the storage unit, the operability in log-in processing and the operability in the user switching can be further improved. As a modified example of the USB device being the device 214 shown in FIG. 5, the USB device having the storage unit according to the modified example of the first embodiment can be given in FIG. 10. In this USB device, a controller 55 is connected to a connector 53, and is connected to a flash memory 56 being the storage unit from the controller 55. Additional information (FIG. 2) is further stored in the storage area of the flash memory 56 in which prescribed data is stored. The additional information is the information regarding for example functions of the substrate processing apparatus to perform a specific operation of data backup, maintenance, file execution, recipe editing, and parameter editing such as a function of starting backup of data subsequently after the user switching (data backup function), a function of starting maintenance (maintenance function), a function of executing a file such as a recipe file (file executing function), a recipe editing start function, and a parameter editing start function. A plurality of USB devices having such additional information are preferably prepared depending on a purpose of the control for starting operation.

According to this modified example, the function of the control program 40 is also improved, corresponding to the additional function of the USB device having the storage unit. More specifically, the storage section 411 for transferring data collected from the substrate processing apparatus to the USB device is required between the setting adjuster 406 and the apparatus controller 412.

The authentication section 402 reads the additional information included in the USB device, then controls the operation controller 414, and displays an indication screen indicated based on the additional information afteruser switching. When the read additional information is the information regarding a data backup function, the authentication section 402 changes a storage destination of the backup data set by the setting adjuster 406 under control of the operation controller 414, to the storage unit of the USB device. Further, when the read additional information is the information regarding the maintenance function, a part of the apparatus to be subjected to maintenance is set by the setting adjuster 406, and the set part is stored in the storage section 411. Further, when the USE device is inserted into the USB port during processing of the substrate, the operation controller 414 is configured to stop the execution of the file for processing the substrate stored in the parameter storage section 410. Further, when the execution of the file is stopped, the operation controller 414 outputs an instruction to the apparatus controller 412 regarding a safe processing by a safe file previously stored in the storage section 411, and controls the apparatus controller 412. Note that the function defined by the aforementioned additional information is given as an example, and it is matter of course that the function is not limited thereto.

More specifically, the data backup function, the maintenance function, and a shifting function to a safe file, will be given hereafter as examples for explanation.

(Data Backup Function)

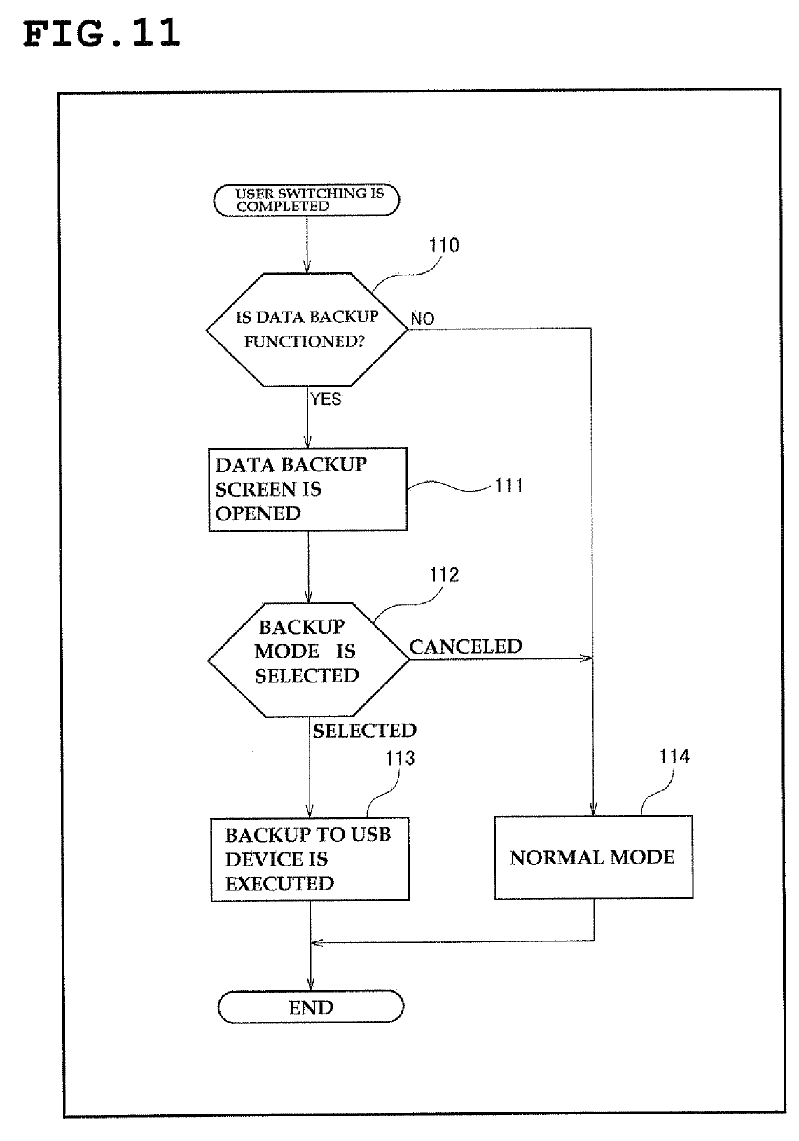

The data backup function of the USB device will be described first. As shown in FIG. 11, after completion of the log-in processing (user switching), in step 110, the operation controller 414 of the control program 40 judges whether or not the data backup function is assigned to a prescribed storage area of the USB device, and when it is so judged that the data backup function is assigned thereto, processing is advanced to step 111, and otherwise, processing is returned to a normal mode of step 114. The normal mode 114 here is a state that the user log-in is completed in FIG. 9 as described above. Therefore, the initial screen of the user level based on the authentication data is displayed.

In step 111, the operation controller 414 displays the data backup screen (FIG. 3(a)) on the displayer 210. The operation controller 414 judges whether or not a start button is selected and a backup mode is selected by the input unit 213 (step 112), and when a part to be backed up read from the storage section 411 is selected, the processing is advanced to data backup execution processing of step 113, and otherwise, the processing is advanced to the processing of step 114 in a case of a cancel.

In step 113, the setting adjuster 406 controlled by the apparatus controller 412 receives data selected to be backed up, from the storage section 411 through a user interface section (UI section) 400 (FIG. 2).

Thus, when the data backup function is assigned to the USB device, the data backup screen is opened after completion of the user switching only by inserting the USB device, and therefore the operability in the user switching can be further improved. Further, the operation can be performed by the user only in a case of a specific operation, and therefore the risk of the incorrect operation or leak of screen information is reduced, and reliability and safety of the apparatus can be further surely secured.

(Maintenance Function)

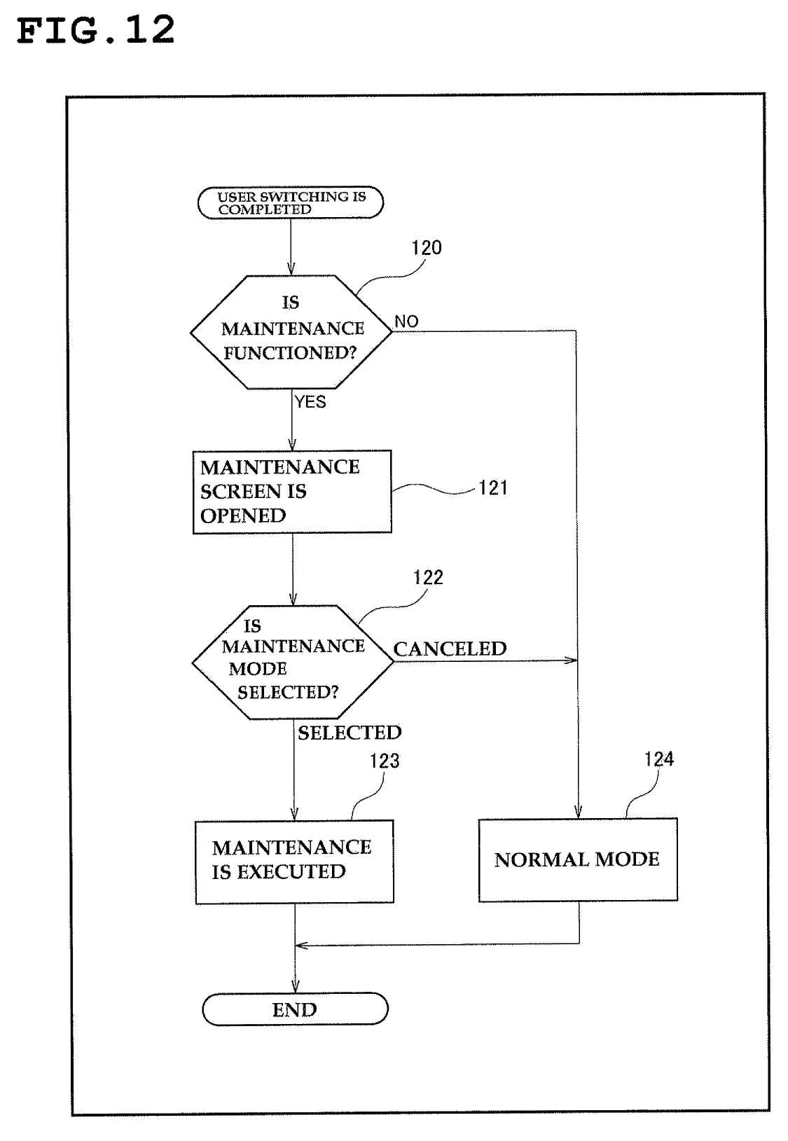

The maintenance function of the USB device will be described next. As shown in FIG. 12, in step 120, the operation controller 414 of the control program 40 judges whether or not the maintenance function is assigned to a prescribed storage area of the USB device, and when it is so judged that the maintenance function is assigned thereto, processing is advanced to step 121, and otherwise, the processing is returned to the normal mode of step 124. The normal mode 124 here is the same state as the completion of the user log-in of FIG. 9 as described above. Therefore, the initial screen is displayed here.

In step 121, the operation controller 414 displays the maintenance screen (FIG. 3(b)) on the displayer 210. The operation controller 414 judges whether or not the start button is selected and the maintenance mode is selected by the input unit 213 (step 122), and when a prescribed apparatus part to be subjected to maintenance is selected, the processing is advanced to the processing of step 123, and otherwise, in a case of being canceled, the processing is advanced to step 124. In the case of being canceled, and when the processing is advanced to the processing of step 124, the processing is not returned to the processing of step 122. Therefore, in a case of being erroneously canceled, the USB device needs to be extracted again.

In step 123, the setting adjuster 406 controlled by the apparatus controller 412 gives instruction to the substrate processing apparatus to execute maintenance to a part of the apparatus being a maintenance object, so that maintenance can be executed.

Thus, when the maintenance function is assigned to the USE device, the maintenance screen is opened subsequently after user switching is completed, and therefore the operability in the user switching can be further improved. For example, the operation screen is displayed, to execute the recipe for cleaning, or to execute the recipe for N₂-purging the inside of the processing chamber 29 so as to be opened in the atmosphere.

As described above, by assigning a specific operation to the USB device having the storage unit, and registering this USE device in the user DB at the apparatus side, the specific operation can be automatically executed after user switching. Therefore, the operability in the user switching can be further improved. In addition, the specific screen is displayed in which the user can perform a specific operation, so that the specific operation can be performed by the user. Therefore, there is no risk of being led into an operation impossible state due to erroneous operation by the user, and leak of important information from an unintentional screen can be prevented.

(Shifting Function of a Safe File)

Incidentally, as described in this embodiment, when each kind of function can be executed using the USB device, there is sometimes a problem that the USB device is unintentionally inserted into the USB port during processing the substrate. Therefore, in this modified example, when the USB device is inserted into the USB port during processing of the substrate, execution of the file for processing the substrate is stopped.

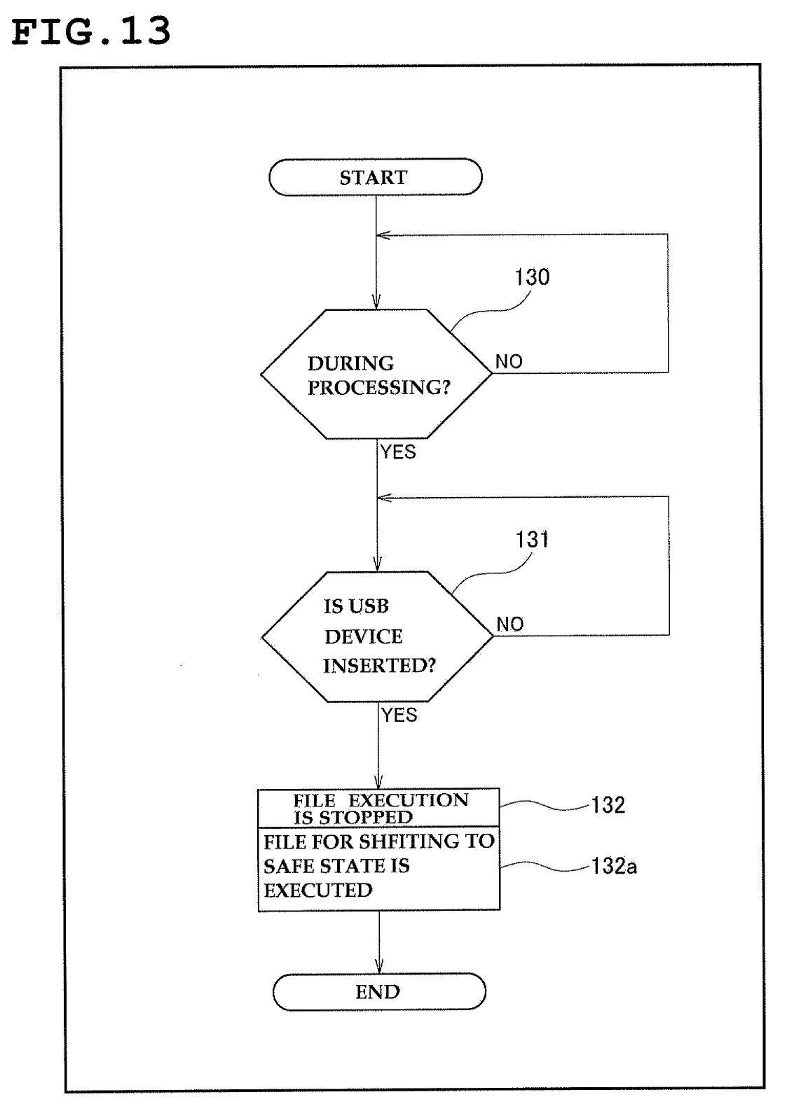

As shown in FIG. 13, during processing of the substrate by the file prepared or edited for processing the substrate (step 130), usually under control of the operation controller 414 based on the control program, the screen for monitoring an operation state of the substrate processing apparatus (FIG. 3(d)) is displayed on the displayer 210 of the operating section 201. During such a processing of the substrate, the operation controller 414 judges whether or not the USB device is inserted into the USB port (step 131), and in a case of the registered USB device, the apparatus controller 412 gives instruction to the substrate processing apparatus to stop the execution of the file for processing the substrate, and controls the substrate processing apparatus (step 132). As an example of stopping the execution of the file, an execution file is switched to a file for shifting the substrate processing apparatus stored in the storage section 411 to an idling state for example, and this file is executed for shifting the apparatus state to a safe state (step 132a). In this case, the apparatus state can be shifted to a further safe state.

(Display of a Prescribed Button)

Incidentally, as described above, when the USB device having the storage unit is extracted from the USE port, an unmounting operation needs to be performed. When the USE device is extracted suddenly, there is a possibility that failure of the USE occurs, resulting in loss of data. Therefore, a control program is added for safely performing the unmounting operation, and display of the button on the operation screen is designed as follows.

When the USE device is not mounted on the USE port, the operation controller 414 of the control program 40 is configured to control the authentication section 402, so that the prescribed button on the initial screen (operation screen) such as a menu screen is displayed on the displayer 210 as non-active, to thereby prohibit pressing of the button (FIG. 3(c)). Here, the prescribed button is a button 52 for displaying right or wrong of the unmounting operation for example (FIG. 3(e)). As an example of non-active display, color of the prescribed button is preferably set to a similar color as background color. Thus, the prescribed button can be ignored when the USE device is not inserted.

Further, when the USB device is inserted into the USB port, the operation controller 414 is configured to control the authentication section 402, to display the prescribed button as active in an area (portion) where the operation screen is not switched even by a previously determined operation on the operation screen of the display part 210, or even by a changeover display operation of the operation screen for monitoring the operation state of the substrate processing apparatus (FIG. 3(d)), thus always reminding the user when the USB device is inserted.

Preferably the operation controller 414 displays warning on the operation screen of the displayer 210, which is the warning for notifying the user of removal of the USB device without pressing the button 52, when the USB device is removed from the USB port without pressing the button 52 for indicating right or wrong of the unmounting operation (FIG. 3(e)). Thus, safety of data protection can be further increased. Further preferably, when the USB device is extracted without pressing the button 52, it is desirable not to complete the log-out processing. Then, the user presses the button 52 as one procedure of the log-out processing, and therefore the safety of the data protection can be further increased. In addition, in a state of simply not completing the log-out processing, there is a risk of erroneous operation by other user, and therefore when the USE device is extracted without pressing the button 52, it is further preferable to prohibit the operation (system lock). Then, further safety of the apparatus is secured. In this case, a system lock is released by inserting the USE device for releasing system lock, and the log-out processing is completed by extracting the USE device for releasing system lock. With this structure, it is a matter of course that the operability is further improved.

### Second Embodiment

A second embodiment of the present invention will be described next. According to this embodiment, a different point from the first embodiment is that changeover of the display state of the operation screen is further performed. In the description hereafter, the same signs and numerals are assigned to a constitutional feature having a similar function and a similar structure as the structure of the first embodiment, and description thereof is omitted.

The operation screen displayed on the displayer 210 includes large volume of information to be kept private which is not desired to be known to a third person, such as the operation recipe and the apparatus parameter based on various knowledge, and the information showing downtime of the apparatus and trouble contents, etc., which is a key to know the performance of the apparatus. Therefore, when the operation screen is left, with such information displayed thereon, there is a risk that a person having no user authority sneaks a look at or rewrites important information.

In order to reduce such a risk, as a reference example of this embodiment, after elapse of a fixed time without performing the screen operation, the following countermeasure is possible. Namely, a screen-saver screen, etc., is started and the operation screen of the displayer is set in a non-display state. Further, when the operation screen is displayed again, input of the user ID, input and approval of the password, are requested. This contributes to further reduction of the risk of information leak, etc.

However, the aforementioned technique of inputting the password involves a similar problem as the problem of the first embodiment. For example, there is a restriction as follows: the display state of the displayer is not switched unless a fixed time is elapsed, or the aforementioned technique can't be used for the substrate processing apparatus not having the input device such as a keyboard. Therefore, evasion of the risk of the information leak is insufficient. Further, when setting of the fixed time is shortened, input of the user ID and the password is frequently requested on the contrary, and therefore the operability becomes poor.

Therefore, according to this embodiment, the risk of the information leak is reduced and the operability in log-in processing and log-out processing of the first embodiment is further improved, by performing changeover of the display state of the operation screen at the time of insertion/extraction of the device 214.

(2-1) Control Program

Explanation will be given for the function of the control program 40 executed by the operating section 210 of the substrate processing apparatus according to this embodiment, with reference to FIG. 8. The control program 40 according to this embodiment also has a similar function as the function of the first embodiment.

Further, when the device 214 is inserted into the mounting section 211, the authentication section 402 being a data authentication unit completes the log-in processing similarly to the first embodiment, and when the device 214 is extracted from the mounting section 211, the authentication section 402 completes the log-out processing. In this embodiment, a state that the log-out processing is completed, means a state that the authority of operating the apparatus of all user levels is canceled, namely a state that no one performs log-in processing, and a state that the authority of the user is returned to the former user level.

Further, when the device 214 is inserted and the log-in processing is completed, the operation controller 414 being the display control unit is configured to display at least a part of a prescribed operation screen on the displayer 210 of the operating section 201. At this time, the operation controller 414 is configured to control the display state on the displayer 210 based on the user level authenticated by the authentication section 402 for example. Namely, in the operation screen, the operation controller 414 is configured to control to display a portion that can be disclosed to a user of a low user level, specifically a fixed display area which is not switched even by a changeover display operation of the operation screen, or only a warning display, or the whole part of the operation screen, depending on the user of a high user level.

Further, when the device 214 is extracted and the log-out processing is completed, the operation controller 414 is configured to perform changeover of at least a part of the display state in the operation screen of the displayer 210. Changeover of the display state includes changeover from a prescribed operation screen to other prescribed screen, and changeover from the prescribed operation screen to a non-display state, or the like. At this time, in the operation screen displayed on the displayer 210, the operation controller 414 is configured to control the display state on the displayer 210 as follows: only a portion prohibited to be disclosed is set in the log-out state, specifically only a portion excluding the aforementioned fixed display area and warning display, etc., is set in the non-display state, or the whole body of the operation screen in the non-display state is set in the non-display state or is switched to other prescribed screen. Wherein, the non-display state of the operation screen includes a state that blackout is caused in the screen, a state that the screen has a low luminance, and a state that the screen covering the whole body of the operation screen like a screen-saver, to thereby set the operation screen as non-display. Thus, particularly when the operation screen is set in the non-display state, long life span of the displayer 210 is achieved.

Such a changeover setting of the display state and a startup program are readably stored in the storage section 411, etc., for example, and when the display state of the operation screen is switched, the startup program is read and executed by the operation controller 414 through the setting adjuster 408.

Further, the operation controller 414 is configured to judge whether or not the device 214 is inserted into the mounting section 211, and control the displayer 210 to perform changeover of the display state of at least a part of the operation screen in a state that the device 214 is extracted. The state that the device 214 is extracted, includes a state that no one executes the log-in processing yet after starting the substrate processing apparatus, in addition to a state that the inserted device 214 is extracted.

Note that the operation screen of this embodiment includes a data backup screen, a maintenance screen, an apparatus operation state monitoring screen, an editing screen of recipe and parameters, an authentication screen (log-in screen), and an initialization screen (for example menu screen), etc. The operation controller 414 is configured to display an arbitrary operation screen in accordance with a status and setting at each time. For example, after starting the substrate processing apparatus until completion of the log-in processing, the operation screen excluding a prescribed screen such as the initialization screen may be set in the non-display state. Further, when the log-in processing is completed, it is also acceptable that a prescribed operation screen is always displayed, the operation screen responding to the user level is displayed, or the operation screen displayed before the most recent log-out processing is displayed.

(2-2) Control Processing of the Substrate Processing Apparatus

Control processing of the substrate processing apparatus according to this embodiment will be described next. Note that in the description hereafter, the device 214 is assumed to be the USB device, and the mounting section 211 is assumed to be the USB port.

(Display of the Operation Screen)

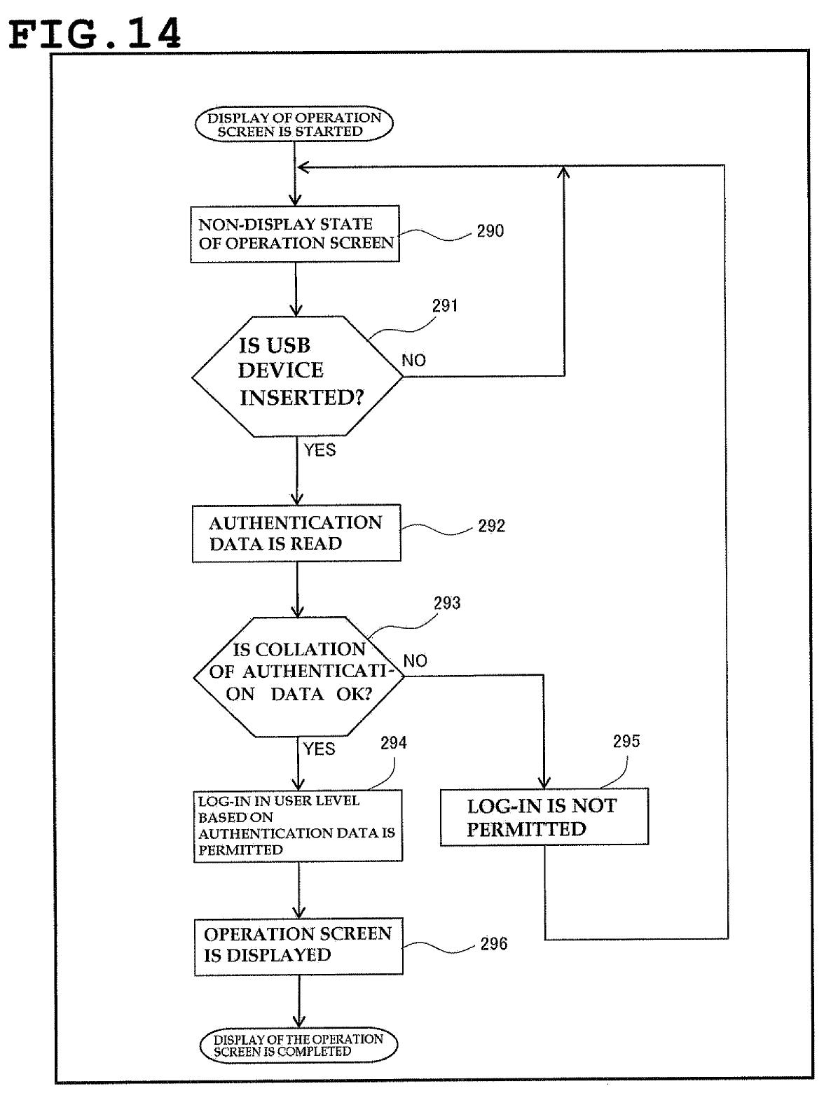

FIG. 14 is a flowchart showing the control processing of the display on the operation screen by the substrate processing apparatus. Although this is a function corresponding to that of FIG. 9 of the first embodiment, a different point is that the prescribed operation screen is displayed in the log-in processing by inserting the USB device.

In step 290 shown in FIG. 14, for example the operation screen is set in the non-display state on the displayer 210 of the operating section 201. Such a state can be a state that no one executes the log-in processing yet after starting the substrate processing apparatus, and as will be described later, can be a state after completion of the log-out processing by extracting the inserted USB device. In this state, the operation controller 414 judges whether or not the USB device is inserted into the USB port (step 291), and when the USB device is inserted, processing is advanced to the processing of step 292, and otherwise, step 290 and step 291 are repeated while maintaining the non-display state of the operation screen.

Next, similarly to the aforementioned embodiment, the user password, etc., is read from the USB device without displaying the authentication screen (log-in screen) (step 292), and right and wrong of the authentication data is judged. Note that at this time, the screen (for example, a message screen) showing “under collation” may be displayed (step 293). When the authentication data is judged to be right (OK), the log-in processing is completed (step 294), and the operation controller 414 displays the operation screen corresponding to the authenticated user level (step 296). When the authentication data is judged to be wrong (NG), the log-in is not permitted (step 295), and the processing is returned to step 290 without displaying the operation screen. Note that at this time, the screen showing “collation NG” (for example, the message screen) may be displayed.

Note that after the operation screen is displayed, the user permitted to execute log-in selects a function button that can be used on the menu screen, to thereby perform various operations.

Thus, only by inserting the USB device into the USB port, for example the operation screen set as non-display can be displayed, and subsequently the operation corresponding to the user level can be performed. Therefore, the operability in the log-in processing can be further improved.

(Changeover of the Display State of the Operation Screen)

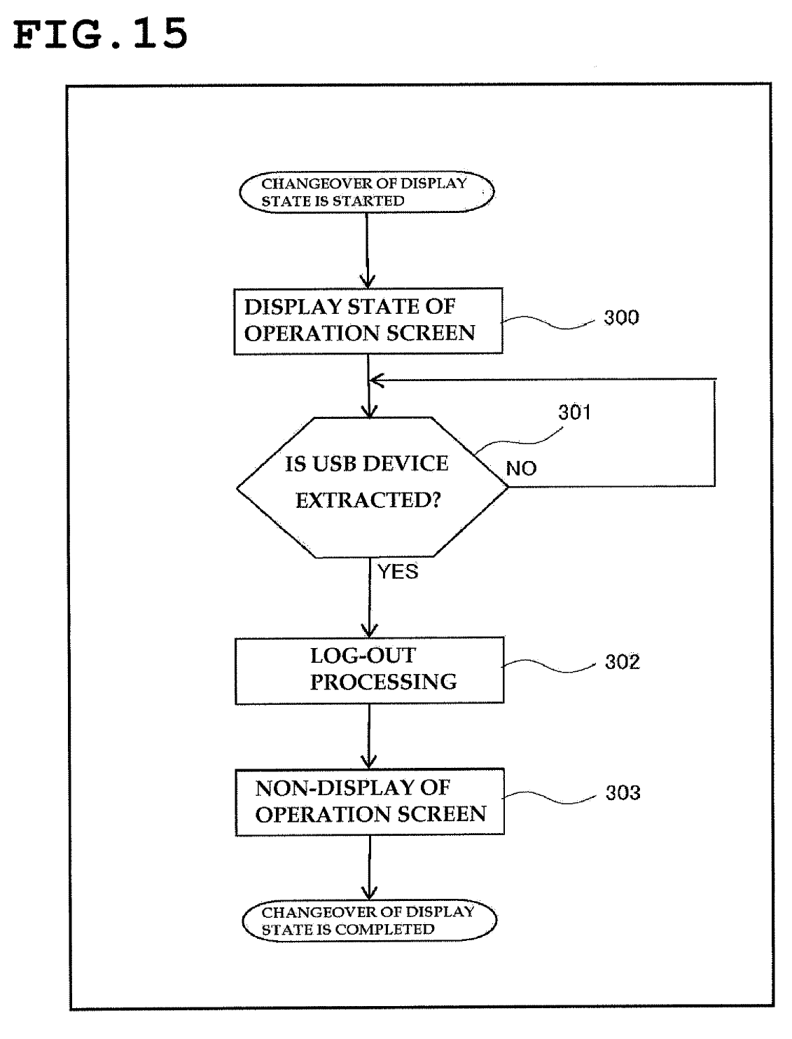

FIG. 15 is a flowchart showing changeover control processing of the display state of the operation screen by the substrate processing apparatus according to this embodiment. By this control processing, the display state of the operation screen is switched in the log-out processing by extracting the USB device.

In step 300 shown in FIG. 15, for example the prescribe operation screen is displayed on the displayer 210 of the operating section 201. This state is a state that for example the USB device is inserted and the log-in processing is completed. In this state, the operation controller 414 judges whether or not the registered USB device is extracted from the USB port (step 301). When the registered USE device is extracted, the authentication section 402 completes the processing without displaying the authentication screen (log-in screen) (step 302), and the operation controller 414 sets the operation screen in non-display (step 303). Otherwise, step 300 and step 301 are repeated while maintaining the display state of the operation screen. Further, a prescribed extraction procedure may be added in accordance with the kind of the USB device.

Thus, only by extracting the USB device from the USB port, the operation screen can be set in the non-display for example. Therefore, the operability can be further improved in the log-out processing. Further, the operation screen is set in non-active when the operation screen is in a completion state of the log-out processing (a state that the USB device is extracted), namely the operation screen is set in non-active when there is a high possibility that no one operates the substrate processing apparatus. Therefore, the following case rarely occurs, such that the operation screen is left while displaying information, and a risk that a person having no user authority sneaks a look at or rewrites important information.

In addition, the substrate processing apparatus according to this embodiment may be configured so that the operation screen can be displayed by inputting the password, etc., through the input unit 213 without using the USB device, from the non-display state of the operation screen. In this case, the authentication data such as inputted password, may be different from the authentication data provided in the USB device. This authentication data is collated with the data for device authentication or input content authentication, which is previously registered in the operating section 201 of the substrate processing apparatus, and when the authentication data is matched with either one of the aforementioned data, the log-in processing is completed.

Further, the operating section 201 of this embodiment may also be configured not to receive all inputs through the mounting section 211 and the displayer 210, etc., when the operation screen is in a state of extracting the USB device. Such an input also includes insertion of the USE device. Here, it is also acceptable that the operating section 201 receives but a prescribed input such as an input of command like initialization processing, data backup, and maintenance, an input for a preparing and editing work of a prescribed file. However, by not receiving the input including the insertion of the USB device, the risk of the information leak can be further reduced. Further, it is also acceptable that only the specific input can be received.

Further, the operation controller 414 of this embodiment may also be configured to display at least a part of the prescribed operation screen when the USB device is extracted, and the display state of at least a part of the operation screen is switched when the USB device is inserted. Such a structure is useful for preventing the prescribed operation screen to be viewed by a third person, or prohibiting a prescribed operation from being performed from the operation screen by the third person, by inserting the USB device by an operator who starts a work required at the time of generating abnormality of the substrate processing apparatus or at the time of maintenance.

(2-3) Effect of this Embodiment

According to this embodiment, one or a plurality of effects given below can be exhibited, in addition to the effect of the first embodiment.

When the device 214 is extracted and the log-out processing is completed, the operation controller 414 of this embodiment is configured to perform changeover of the display state of the prescribed operation screen. Thus, the operability in the log-out processing can be further improved.

Further, the operation controller 414 of this embodiment is configured to perform changeover of the display state of at least a part of the operation screen. Thus, the information according to the user level can be selectively displayed or the information for securing safety can be positively displayed. Therefore, a desired operation can be performed with a simple structure, irrespectively of each user level, and as a result, the operability can be significantly improved.

Further, the operation controller 414 of this embodiment is configured to set the prescribed operation screen in non-display when the device 214 is extracted. Thus, when the operation screen is in the completion state of the log-out processing, namely when there is a high possibility that no one operates the substrate processing apparatus, the following case rarely occurs, such that the operation screen is left while displaying information, and the non-display state is maintained even when the user authority is returned to the former user, and therefore the following risk can be prevented, such that a person having no user authority sneaks a look at or rewrites important information.

Further, when the operation screen is set in the non-display state, the operation controller 414 of this embodiment is configured to set the operation screen in a blackout state, a low luminance state, and a screen-saver screen start state, etc. Thus, the life span of the displayer 210 can be prolonged.

Further, in an extraction state of the device 214, the operating section 201 of this embodiment is configured not to receive input to the operating section 201. Thus, the risk of leak and rewrite of the information on the operation screen can be further reduced.

Further, in the extraction state of the device 214, the operating section 201 of this embodiment is configured not to display a prescribed operation screen, unless the input of the authentication data by the input unit 213, etc., or the log-in processing such as mounting the device again, is completed. Thus, the risk of leak or rewrite of the information on the operation screen can be further prevented.

(2-4) Modified Example of this Embodiment

Next, the device according to a modified example of this embodiment will be described hereafter.

The device according to this modified example has a flash memory 56 being a storage unit for example, similarly to the USB device shown in FIG. 10 of the first embodiment. Additional information for giving an additional function to the USB device, is stored in the flash memory 56. Several additional functions given by the additional information is listed as follows.

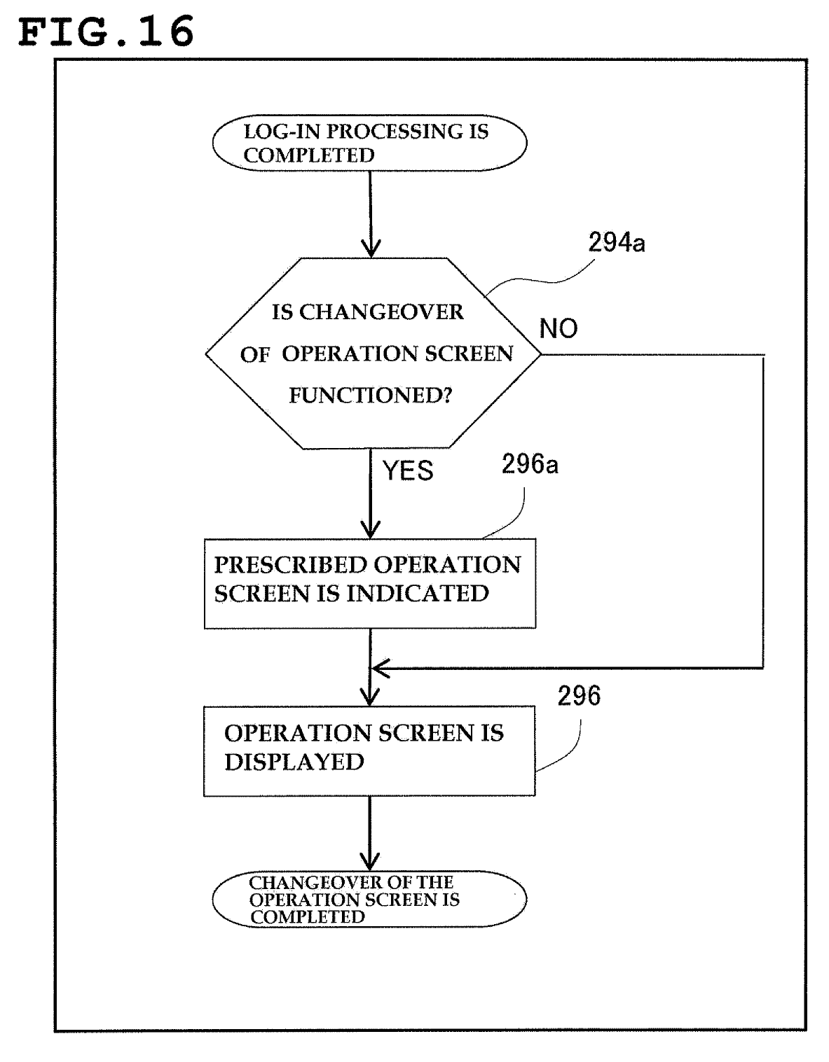

As an example of the additional function, explanation will be given for an operation screen changeover function for displaying a prescribed operation screen after completion of the log-in processing by inserting the USB device. In FIG. 16 showing the state after completion of the log-in processing (corresponding to step 294 of FIG. 14), when the inserted USB device has the operation screen changeover function (step 294a-*YES), the information of the operation screen previously stored in the flash memory 56 of the USB device is read by the authentication section 402, and executed by the operation controller 414, then the prescribed operation screen is indicated (step 296a), and this information is displayed in this operation screen (step 296). When the USB device does not have the operation screen changeover function (step 294a→NO), the operation screen is not indicated, and for example the prescribe operation screen such as a log-in processing completion screen is displayed (step 296).

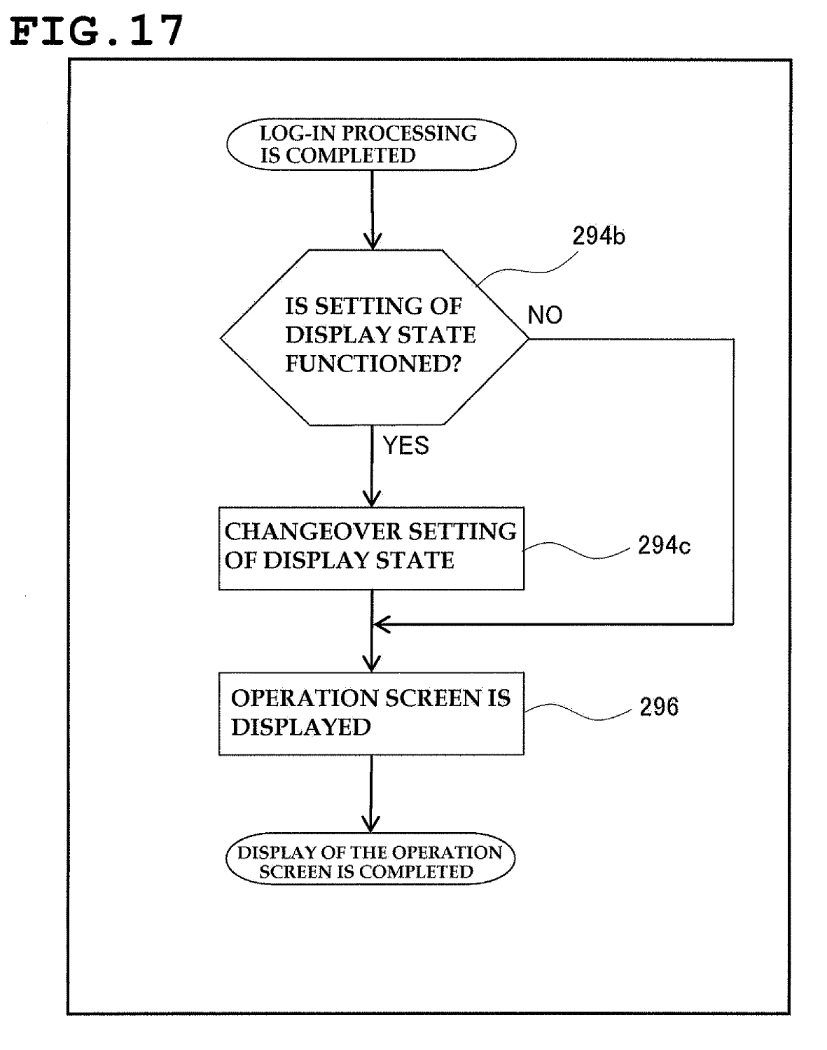

As other example of the additional function, explanation will be given for a display state setting function for performing changeover setting of the display state after extracting the USB device. In FIG. 17 showing the state after completion of the log-in processing (corresponding to step 294 of FIG. 14), when the inserted USB device has the display state setting function (step 294b→YES), the information regarding prescribed changeover setting previously stored in the flash memory 56 of the USB device such as changeover to a prescribed screen, changeover to the blackout state, low luminance state, and screen-saver screen start state, is read by the authentication section 402, and write or rewrite is performed to the storage section 411, etc., through the setting adjuster 406 by the operation controller 414 (step 294c). After such setting/resetting (rewriting), the operation screen is displayed (step 296). When the USB device does not have the display state setting function (step 294b→NO), the above-described flow is followed. Note that step 296 may be performed before step 294b or may be performed in parallel to steps 294b to 294c. Thereafter, when the USB device is extracted, the display state of the operation screen is switched in accordance with a new setting written into the storage section 411, etc.

Thus, according to a structure that the USB device having the flash memory 56 has a part of the function of the substrate processing apparatus for performing a specific operation such as changeover of the operation screen and setting the display state, storage capacity of the substrate processing apparatus can be reduced. Further, according to a structure that a plurality of USB devices are prepared for each of the several additional functions, multifunction is achieved in the operation in log-in processing and log-out processing, even if not changing the function or changing the setting of the substrate processing apparatus itself, and the operability can be further improved.

### Third Embodiment

A third embodiment of the present invention will be described next. According to this embodiment, the specific operation is automatically executed, when the device is inserted and the log-in processing (including user interruption processing) is completed. At this time, a different point from the aforementioned embodiment is that the operation screen is set in non-display. A part or the whole part of the operation screen including the information, etc., desired not to be disclosed to the third person for example, is set in non-display. In the description hereafter, the same signs and numerals are assigned to a constitutional feature having a similar function and similar structure as the aforementioned function and structure of the first embodiment,

The device of this embodiment has the same structure as the structure of the USB device shown in FIG. 10 for example. An operation procedure is stored in the flash memory 56 being the storage unit included in this USB device, so that the operating section 201 of the substrate processing apparatus performs a specific operation such as collecting error logging data. The operation controller 414 realized by the operating section 201 is configured to read and execute the operation procedure included in the flash memory 56.

Further, the operation controller 414 being the display control unit is configured to set at least apart of the operation screen in non-display when the aforementioned specific operation is performed. The non-display state of the operation screen includes the blackout screen similar to a case that power supply of the substrate processing apparatus is disconnected, or the low luminance screen, and the screen-saver screen, etc. Thus, the following risk can be prevented, such that a third person sneaks a look at or rewrites important information, during automatic operation based on the operation procedure. Further, the non-display state of the operation screen may be automatically released when the specific operation is ended. Here, it is preferable to keep the non-display state until the operator performs the operation of releasing the non-display state from the input unit 213 when receiving end notification of the operation as will be described later, or until the USB device is extracted. Note that when the specific operation is normally ended, the USB device may be automatically set in a removal state.

Further, the operation controller 414 is configured to notify the user of the end of the specific operation by a prescribed unit. As the prescribed notification unit, auditory means such as an alarm sound and visual means such as color and blinking of a warning lamp, can be given. Further, it is also acceptable that by properly using the tone of the alarm sound, color and blinkering of the warning lamp, or using the alarm sound and the warning lamp for different purposes, an end state of the operation, namely whether or not the operation is ended normally or abnormally, can be judged.

Further, when the specific operation is ended abnormally, the operation controller 414 is configured to display a previously indicated specific operation screen. Namely, even in a case that the operation screen is kept to be the non-display state even after the end of the specific operation, the specific operation screen is displayed in the case of the abnormal end. Such an operation screen includes, for example an abnormal state confirmation screen displaying an error message and capable of confirming the abnormal state, and an abnormal state recovering screen, etc., displaying buttons, etc., for canceling and resetting the specific operation and promoting the recovery of the abnormal state.

An operation procedure for performing the specific operation by the substrate processing apparatus may be stored in the storage section 411, etc., provided in the substrate processing apparatus. In this case, when the USB device is inserted and the log-in processing is completed, the operation controller 414 is configured to read and execute the prescribed operation procedure stored in the storage section 411, etc. Further, it is also acceptable that data for the prescribed operation procedure is previously registered in the storage section 411, etc., and when identification information specific to the USB device such as authentication data integrated into the USB device are matched with the aforementioned data, the specific operation is performed.

Further, it is also acceptable that an operation screen non-displaying function for setting the operation screen as non-display, and a notifying function for notifying the user of the end of the aforementioned specific operation, and a function of displaying an operation screen at abnormal time for displaying the prescribed screen at the end of the abnormal state, are included in the USB device. The operation controller 414 realizes the above-described each function, in accordance with the indicated information from the USB device.

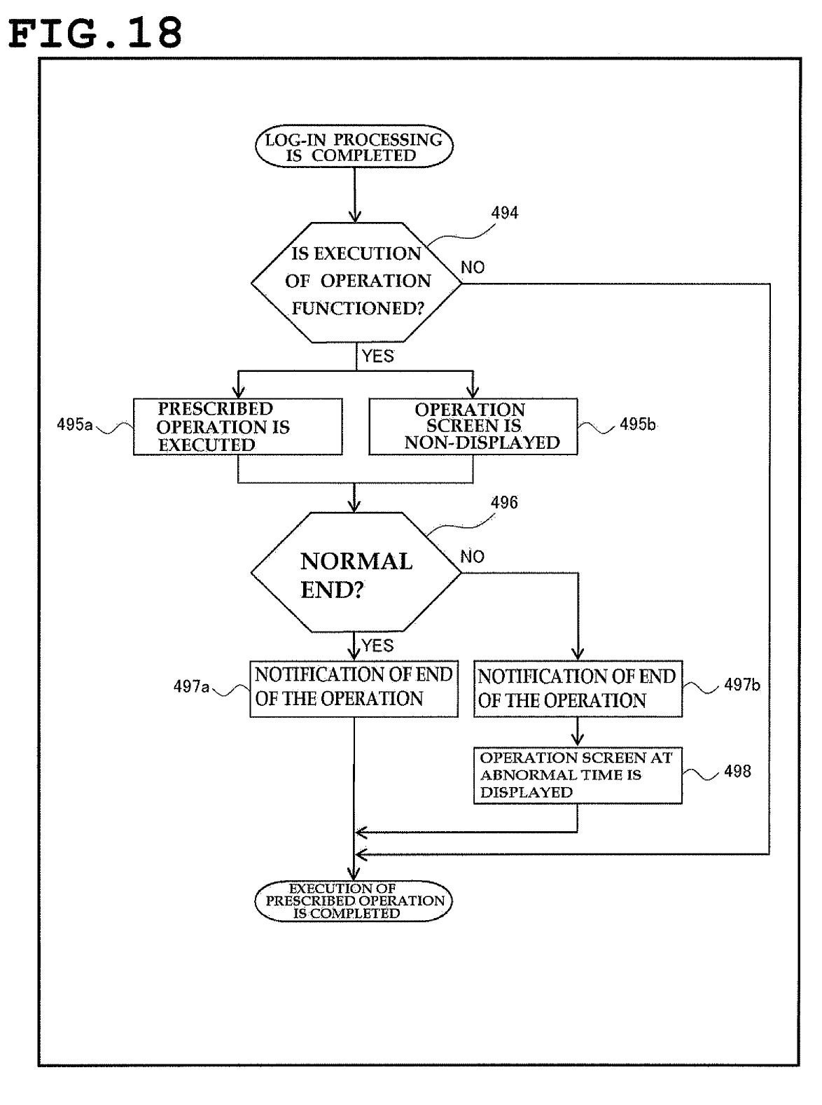

A flow of an automatic execution of the specific operation will be described hereafter using FIG. 18.

As described above, the specific operation includes collection of data, etc., used for analysis of data such as error logging data. Here, the explanation will be given on the assumption that the USE device includes the operation procedure for collecting the error logging data.

When the log-in processing is completed by inserting the USE device (corresponding to step 494: step 94 of FIG. 9 in the aforementioned embodiment, and step 294 of FIG. 14) in case that the USB device has a specific operation executing function, specifically a collecting function for collecting the error logging data (step 494→YES), the operation controller 414 that reads the operation procedure controls the setting adjuster 406 to read the error logging data from the storage section 411 for example in accordance with the operation procedure, to execute the specific operation by controlling the USB device to collect the error logging data through UI part 400 (step 495a). Further, at least a period of executing the specific operation, the operation controller 414 controls the operation screen to be non-display (step 495b), to be non-display even after end of the specific operation preferably. When the specific operation is ended, the operation controller 414 judges whether the specific operation is ended normally or abnormally (step 496), and when the specific operation is ended normally, the user is notified of the end of the operation (step 497a). When the specific operation is ended abnormally, the user is notified of the end of the operation (step 497b), and an operation screen at abnormal time is displayed (step 498). As described above, automatic execution of the specific operation is ended. Note that when the USB device does not have the operation executing function (step 494→NO), the automatic execution is ended without executing the specific operation.

For example, in a case of the data collection such as the error logging data, a large volume of data needs to be collected in some cases, thus requiring a long time work in some cases. However, according to this embodiment, data collection is executed automatically in accordance with the prescribed operation procedure, and therefore there is no necessity for carrying out the work with constant attendance of the operator, thus making it possible to reduce a load of the operator and achieve the efficiency of the work. Therefore, the operability in the log-in processing can be further improved.

In addition, the specific operation performed by the substrate processing apparatus in this embodiment may be the data backup or the maintenance, or the shift to the safe state as described in the above-described embodiment. In this case, the procedure of such an operation is performed in such a manner that the USB device stored in the flash memory 56 is inserted, and when the log-in processing is completed, the specific operation is performed automatically under control of the operation controller 414.

In this embodiment as well, the aforementioned effect of the embodiment is exhibited.

Further, in addition to the aforementioned effect of the embodiment, according to this embodiment, the operating section 201 is configured to perform the specific operation when the USB device is inserted into the mounting section 211 and the log-in is completed. Thus, the specific operation can be executed and ended only by inserting the USB device, and the operability in the log-in processing can be further improved.

Further, according to this embodiment, when the USB device is inserted into the mounting section 211 and the log-in is completed, the operation controller 414 is configured to set a display state of at least a part of the operation screen in no-display, and maintain the non-display state while performing the specific operation by the operating section 201. Thus, the risk of the information leak and rewriting of information, etc., is reduced. Such a function is further useful when the operator does not attend nearby constantly during automatic execution of the operation.

Further, according to this embodiment, the operating section 201 is configured to notify the user of the end of the specific operation or the end state of the operation by auditory means or visual means. According to this embodiment, the end of the operation can be known, and therefore this embodiment is useful particularly when the operation screen is set in the non-display state. Further, whether the operation is ended normally or the operation is ended abnormally can be judged.

Further, according to this embodiment, when the specific operation is ended abnormally, the operation controller 414 is configured to display a previously indicated specific operation screen such as an abnormal state confirmation screen or an abnormal state recovering screen. Thus, even when certain abnormality is generated, it can be coped with immediately. Particularly, when the operation screen is set in the non-display state, the abnormal state is displayed immediately, and therefore this embodiment is useful.

Further, according to this embodiment, the USE device has an operation executing function of controlling the operating section 201 to execute the specific operation, and is configured to perform the specific operation using the operating section 201. Thus, the operability in the log-in processing can be further improved. Moreover, the specific operation can be performed only by inserting the USE device, and therefore by managing the USE device, a desired operation can be performed irrespective of the user level, and it can be said that this embodiment is preferable in an aspect of manageability by the user.

### Other Embodiment

As described above, embodiments of the present invention are specifically described. However, the present invention is not limited to the above-described embodiments, and of course the present invention can be variously modified in a range not departing from the gist of the present invention.

For example, in the aforementioned embodiments, explanation has been given for a case that the substrate processing apparatus is given as the semiconductor manufacturing device. Moreover, the present invention can be applied not only to the semiconductor manufacturing device but also to an apparatus for processing a glass substrate such as an LCD apparatus. Further, the film formation processing includes, for example, CVD, PVD, the processing of forming an oxide film and a nitride film, and the processing of forming a film containing metal, or the like. Further, although explanation has been given for a vertical type apparatus in the aforementioned embodiment, a single wafer processing apparatus is also acceptable, and other substrate processing apparatus (aligner, lithography equipment, and coating applicator, etc.) are also acceptable. In addition, it is also acceptable that an apparatus is connected to a plurality of substrate processing apparatuses via a communication line so that a state of each substrate processing apparatus can be managed.

<Preferred Aspects of the Present Invention>

Preferred aspects of the present invention will be supplementarily described hereafter.

According to a first aspect of the present invention, there is provided a substrate processing apparatus, comprising:

an operating section including an operation screen for preparing or editing a file for processing a substrate;

the operating section further comprising:

a mounting section for installing an external storage unit and an input unit, and configured to insert and extract a device into which data is integrated, which is the data including at least authentication data such as user ID and user password;

data authentication unit configured to collate data for device authentication registered in the operating section, and the authentication data integrated into the device when the device is inserted into the mounting section, and complete log-in when the authentication data integrated into the device is registered in the data for device authentication;

a display control unit configured to perform changeover of a display state of at least a part of the operation screen, when the log-in is completed; and

an execution unit configured to execute a specific operation in accordance with different data from the authentication data integrated into the device, when the log-in is completed.

Further preferably, the display control unit is configured to set a display state of at least a part of the operation screen in non-display when the device is inserted into the mounting section and the log-in is completed, and maintain the non-display state while the specific operation is performed by the operating section.

Further preferably, the operating section is configured to notify a user of an end of the specific operation by auditory means or visual means.

Further preferably, the display control unit is configured to display a previously indicated specific operation screen such as an abnormal state confirmation screen or an abnormal state recovering screen, when the specific operation is ended abnormally.

Further preferably, in addition to the authentication data, data for executing at least any one of:

an operation executing function which is executed using the operating section to execute the specific operation;

an operation screen non-displaying function which is executed using the display control unit to set the operation screen in non-display;

a notifying function which is executed using the operating section to notify a user of the end of the specific operation; and

a function of displaying an operation screen at abnormal time which is executed using the display control unit to display the specific screen,

is integrated into the device.

Further preferably, the substrate processing apparatus is configured to perform the specific operation using the operating section, and set the operation screen in non-display under control of the display control unit, and notify a user of the end of the specific operation using the operating section, or display the specific operation screen under control of the display control unit.

According to a second aspect of the present invention, there is provided a substrate processing apparatus, comprising:

an operating section including an operation screen for preparing or editing a file for processing a substrate;

the operating section further comprising:

a mounting section configured to insert and extract a device into which data is integrated, which is the data including at least authentication data such as user ID and user password;

a display control unit configured to perform changeover of a display state of at least a part of the operation screen, when the device is inserted into the mounting section; and

a data authentication unit configured to complete log-out of the user, when the device is extracted from the mounting section.

Preferably, there is provided the substrate processing apparatus according to the second aspect, wherein the display control unit is configured to display at least a part of the operation screen when the device is inserted into the mounting section.

Further preferably, there is provided the substrate processing apparatus according to the second aspect, the display control unit is configured to set at least a part of the operation screen in non-display, when the device is extracted from the mounting section.

Further preferably, there is provided the substrate processing apparatus according to the second aspect, wherein the display control unit is configured to display a screen-saver screen and set at least a part of the operation screen in non-display, when the device is extracted from the mounting section.

According to a third aspect of the present invention, there is provided the substrate processing apparatus according to the first aspect or the second aspect, wherein input to the operating section is not received in an extracted state of the device.

According to a fourth aspect of the present invention, there is provided the substrate processing apparatus according to the second aspect, wherein the data authentication unit is configured to collate data for authentication registered in the operating section, and the inputted authentication data, when different authentication data from the authentication data or the aforementioned authentication data for the operating section, is inputted through the input unit provided in the mounting section in the extracted state of the device, and complete log-in when the inputted authentication data is registered in the operating section, and

the display control unit is configured to display at least a part of the prescribed operation screen when the log-in is completed.

In this case, further preferably, the device has an operation screen displaying function of giving an instruction to the display control unit to display the prescribed operation screen, and when the device having the operation screen displaying function is inserted into the mounting section, the prescribed operation screen is displayed.

In this case, further preferably, the device has a display state setting function of giving an instruction to the display control unit to perform changeover setting of a prescribed display state, and when the device having the display state setting function is inserted into the mounting section, the changeover setting of the prescribed display state is performed.

In this case, further preferably, the changeover setting of the prescribed display state is a changeover to at least any one of a blackout state, a low luminance state, and a screen-saver screen startup state.

### DESCRIPTION OF SIGNS AND NUMERALS

201 Operating section
202 Process controller
205 Transport controller
210 Displayer
211 mounting section
212 External storage unit
213 Input unit
214 Device

What is claimed is:

1. A substrate processing apparatus, comprising:
an operating section including an operation screen for preparing or editing a file for processing a substrate, and a mounting section for installing an external storage unit and an input unit,
the operating section further comprising:
a data authentication unit configured to collate data for device authentication registered in the operating section, and authentication data integrated into a device when the device is inserted into the mounting section, which is the device into which the authentication data such as at least user ID and user password is integrated, and configured to complete log-in when the authentication data integrated into the device is registered in the data for device authentication; and
a display control unit configured to perform changeover of a display state of at least a part of the operation screen, when the log-in is completed.

2. The substrate processing apparatus according to claim 1, wherein the operating section is configured to perform a specific operation in accordance with the authentication data when the log-in is completed.

3. The substrate processing apparatus according to claim 2, wherein data for executing at least any one of:
a specific screen displaying function of displaying a screen for confirming data such as daily inspection parameter;
a collecting function of collecting data such as logging data;
a data backup function of performing backup of data such as logging data; and
a file executing function of executing a file such as a prescribed recipe file,
by the operating section as the specific operation, is integrated into the device in addition to the authentication data.

4. The substrate processing apparatus according to claim 1, wherein the data authentication unit is configured to complete log-out when the device is extracted from the mounting section.

5. The substrate processing apparatus according to claim 1, wherein the display control unit is configured to set at least a part of the operation screen in non-display, when the device is extracted from the mounting section.

6. The substrate processing apparatus according to claim 1, wherein the operating section is configured not to receive input to the operating section, when the device is extracted from the mounting section.

7. A substrate processing apparatus, comprising an operating section including an operation screen for preparing or editing a file for processing a substrate, and a mounting section for installing an external storage unit and an input unit,
the operating section further comprising:
a data authentication unit configured to collate data for device authentication registered in the operating section, and authentication data integrated into a device when the device is inserted into the mounting section into which the authentication data such as at least user ID and user password is integrated, and configured to complete interruption processing when the authentication data integrated into the device is registered in the data for device authentication; and
a display control unit configured to perform changeover of a display state of at least a part of the operation screen when the interruption processing is completed.

8. A method for controlling a substrate processing apparatus comprising an operating section including an operation screen for preparing or editing a file for processing a substrate, and a mounting section for installing an external storage unit and an input unit, the method comprising:
collating data for device authentication registered in the operating section, and authentication data integrated into the device, when the device is inserted into the mounting section, which is the device into which the authentication data such as at least user ID and user password is integrated, and completing log-in when the authentication data integrated into the device is registered in the data for device authentication; and
performing changeover of a display state of at least a part of the operation screen when the log-in is completed.

9. A display method executed by a substrate processing apparatus comprising an operating section including an operation screen for preparing or editing a file for processing a substrate, and a mounting section for installing an external storage unit and an input unit, the method comprising:
collating data for device authentication registered in the operating section, and authentication data integrated into the device, when the device is inserted into the mounting section, which is the device into which the authentication data such as at least user ID and user password is integrated, and completing log-in when the authentication data integrated into the device is registered in the data for device authentication; and performing changeover of a display state of at least a part of the operation screen when the log-in is completed.
